(19) United States
(12) Patent Application Publication
(10) Pub. No.: US 2025/0125753 A1
(43) Pub. Date: Apr. 17, 2025

(54) METHODS FOR CONFIGURING A MOTOR DRIVE AND APPARATUSES FOR IMPLEMENTING THE SAME

(71) Applicant: SCHNEIDER TOSHIBA INVERTER EUROPE SAS, Pacy sur Eure (FR)

(72) Inventors: Mohamed Mroueh, Evreux (FR); Al Kassem Jebai, Vernon (FR); Emmanuel Frappé, Boulogne-Billancourt (FR)

(73) Assignee: SCHNEIDER TOSHIBA INVERTER EUROPE SAS, Pacy sur Eure (FR)

(21) Appl. No.: 18/912,655

(22) Filed: Oct. 11, 2024

(30) Foreign Application Priority Data
Oct. 13, 2023 (EP) 23306790.9
Oct. 13, 2023 (EP) 23306791.7
Mar. 15, 2024 (EP) 24305399.8

(51) Int. Cl. H02P 21/34; H02P 21/16; H02P 21/22

(52) U.S. Cl. CPC H02P 21/34; H02P 21/16; H02P 21/22; H02P 2207/01

(57) ABSTRACT

A method is provided for configuring a motor drive for driving an induction motor, which includes a rotor and a magnetic core comprising a magnetic inductance component. The method includes: performing a first Direct Current, DC, current injection of a first DC current value in the motor at standstill during a first predetermined time duration for first magnetization of the magnetic core of the motor; performing, following the first DC current injection, a second DC current injection of a second DC current value in the motor at standstill during a second predetermined time duration for second magnetization of the magnetic core of the motor. The second predetermined time duration is shorter than the first predetermined time duration.

### CROSS-REFERENCE TO RELATED APPLICATIONS

This application claims priority benefit under 35 U.S.C. § 119(d) from European Patent Application No. EP 23306791.7, filed Oct. 13, 2023, European Patent Application No. EP 23306790.9, filed Oct. 13, 2023, and European Patent Application No. EP 24305399.8, filed Mar. 15, 2024, the disclosures of which are incorporated by reference herein in their entirety.

### FIELD

The present disclosure relates to the field of induction motors and their uses, in particular to apparatuses configured for driving an induction motor.

### BACKGROUND

Induction motor drives are typically designed to operate with any induction motor, based on driving parameters which are determined during a measuring phase sometimes referred to as a “motor tuning” phase.

A motor drive is therefore generally not pre-configured so that it can be configured to operate with any motor drive to which it is coupled. As a consequence, a motor tuning phase typically involves performing measurements on the motor drive to determine estimates of tuning parameters or features of the induction motor to which the motor drive is coupled, and use of the determined tuning parameters and features for configuring the motor drive for driving the induction motor.

For example, tuning parameters or features such as the stator resistance, the leakage inductance, and the magnetizing curve of the induction motor may be determined in order to configure the motor drive and achieve an effective regulation of the induction motor. A precise determination of these parameters is desirable in order to optimize the motor behavior for greater effectiveness.

Therefore, tuning these parameters is a critical procedure during commissioning of a motor drive to be configured for driving a given induction motor.

There are two distinct types of tuning procedures of a motor drive for induction motors: rotational tuning, and standstill tuning. A rotational tuning is performed by rotating the motor, whereas a standstill tuning is performed while keeping the motor at standstill. The rotational tuning is known to produce more accurate estimates of the tuning parameters because more accurate measurements can be obtained on a rotating motor than that which can be obtained while the motor is kept at standstill.

However, starting an induction motor for purposes of measuring tuning parameters for configuring the motor drive to be used for driving the motor may constitute a constraint. As a consequence, the standstill tuning is known to be more convenient to use especially in situations where mechanical coupling constitutes a constraint (e.g. in cases where mechanical coupling is laborious to undo or redo).

Standstill tuning procedures of induction motors typically use Direct Current (DC) injections to magnetize the motor's inner magnetic core and analyze the response of the core. Analyzing the response involves performing measurements on the motor while at standstill. As a consequence, the quality of estimation of the tuning parameters depends on the accuracy of the measurements. However, measurement devices which provide accurate measurements even for very low values of measured quantities (such as voltage)—as such is typically the case for measurements performed on a motor at standstill—are not always available, which results in lower quality tuning of the motor at standstill.

There is therefore a need for providing improved schemes for configuring a motor drive and apparatuses implementing the same that address at least some of the above-described drawbacks and shortcomings of the conventional technology in the art.

It is an object of the present subject disclosure to provide improved schemes for configuring a motor drive and apparatuses implementing the same.

Another object of the present subject disclosure is to provide an improved scheme for configuring a motor drive and apparatus implementing the same for alleviating the above-described drawbacks and shortcomings of conventional schemes, in particular in that the proposed scheme for configuring a motor drive may be performed while the induction motor remains at standstill.

### SUMMARY

To achieve these objects and other advantages and in accordance with the purpose of the present subject disclosure, as embodied and broadly described herein, in one aspect of the present subject disclosure, a method for configuring a motor drive for driving an induction motor (e.g. an asynchronous induction motor) is proposed. The method comprises, for an induction motor comprising a rotor and a magnetic core comprising a magnetic inductance component: performing a first Direct Current, DC, current injection of a first DC current value in the motor at standstill during a first predetermined time duration for first magnetization of the magnetic core of the motor, performing, further to the first DC current injection, a second DC current injection of a second DC current value in the motor at standstill during a second predetermined time duration for second magnetization of the magnetic core of the motor, the second predetermined time duration being shorter than the first predetermined time duration.

The proposed method advantageously provides a scheme that may be used for performing configuration of a motor drive in order to drive an induction motor coupled to the motor drive while keeping the motor drive at standstill and using standard-grade measuring equipment, with a reduced duration as compared with conventional tuning sequences. In particular, any standard-grade voltage measurement equipment which does not provide precise measurements for measured voltages below a certain threshold may advantageously be used for implementing embodiments of the proposed motor drive configuration method. This advantageously avoids starting the induction motor for the (sole) purpose of determining parameters of the motor drive that corresponds to measurements performed on the motor drive and allows performing faster standstill tuning of an induction motor using standard-grade measuring equipment.

In one or more embodiments, the proposed method may further comprise: configuring the motor drive based on the first and second DC current injections. As described in further details in the present disclosure, the proposed method advantageously uses at least one DC current injection which is configured shorter than a DC current injection configured for fully magnetizing the magnetic core of the motor. An improved sequence of DC current injections is proposed, which is advantageously shorter than a conventional sequence of DC current injections which typically only uses DC current injections of a duration (or respective durations) configured for fully magnetizing the magnetic core of the motor. Advantageously, the shorter improved sequence of DC current injections may be used (thanks to using a hybrid method) as described herein to determine configuration parameters related to the motor to be driven so that the motor drive may be configured based on the proposed improved sequence of DC current injections.

In one or more embodiments, the second DC current value may be smaller than the first DC current value. For example, in some embodiments, the sequence of DC current injections may be performed with decreasing respective DC current values, which advantageously allows using a maximum DC current value for the first DC current value and benefiting from a shorter period in between two DC current injections (except in some embodiments for the period in between the two first DC current injections) during which the magnetic core of the motor does not get completely demagnetized.

In one or more embodiments, the proposed method may further comprise: Performing a plurality of N subsequent DC current injections in the motor at standstill during respective predetermined time durations, wherein N is an integer greater than 3, wherein the plurality of N subsequent DC current injections includes the first and second DC current injections, and wherein one or more of the respective predetermined time durations of the N−1 DC current injections subsequent to the first DC current injection are shorter than the first predetermined duration of the first DC injection. In some embodiments, the second DC injection may be performed upon end of a first predetermined in-between injection time duration following the first predetermined time duration, and one or more predetermined in-between injection time durations between respective pairs of subsequent DC current injections among the N−2 DC current injections subsequent to the first and second DC current injections may be shorter than the first predetermined in-between injection time duration. In some embodiments, the respective DC current values of the N subsequent DC current injections may be configured decreasing from a DC current value of a j^{th} DC current injection to a DC current value to a subsequent (j+1)^{th} DC current injection. In some embodiments, the proposed method may further comprise: performing each of a plurality of N measurements of a voltage at motor terminals of the motor at standstill during demagnetization of the magnetic core of the motor further to a respective DC current injection of the plurality of N subsequent DC current injections, determining, based on the N voltage measurements, an estimate of the magnetic inductance component of the motor operating in linear regime, determining, based on one of the N voltage measurements, an estimate of a time constant of the rotor of the motor operating in linear regime, and determining an estimate of a rotor resistance of the motor based on the estimates of the magnetic inductance component of the motor and the rotor time constant.

In one or more embodiments, the motor drive may be configured based on the estimate of the rotor resistance of the motor. In some embodiments, the configuration of the motor drive may comprise: for each voltage measurement, determining an estimate of a magnetic flux in the magnetic inductance component of the motor based on the voltage measurement. In some embodiments, the configuration of the motor drive may comprise: determining a plurality of N duplets of current and magnetic flux values, based on the N voltage measurements performed further to injecting respective values of DC current in the motor at standstill for respective time periods.

In one or more embodiments, the motor is an asynchronous induction motor.

In yet another aspect of the present subject disclosure, an apparatus is proposed, which comprises a processor, a memory operatively coupled to the processor, and an interface for coupling to an induction motor to be driven by the apparatus, wherein the apparatus is configured to perform a method as proposed in the present subject disclosure.

In yet another aspect of the present subject disclosure, a non-transitory computer-readable medium encoded with executable instructions which, when executed, causes an apparatus comprising a processor operatively coupled with a memory, to perform a method as proposed in the present subject disclosure, is proposed.

In yet another aspect of the present subject disclosure, a computer program product comprising computer program code tangibly embodied in a computer readable medium, said computer program code comprising instructions to, when provided to a computer system and executed, cause said computer to perform a method as proposed in the present subject disclosure, is proposed. In yet another aspect of the present subject disclosure, a data set representing, for example through compression or encoding, a computer program as proposed herein, is proposed.

It should be appreciated that the present subject disclosure can be implemented and utilized in numerous ways, including without limitation as a process, an apparatus, a system, a device, and as a method for applications now known and later developed. These and other unique features of the system disclosed herein will become more readily apparent from the following description and the accompanying drawings.

### BRIEF DESCRIPTION OF THE DRAWINGS

The present subject disclosure will be better understood and its numerous objects and advantages will become more apparent to those skilled in the art by reference to the following drawings, in conjunction with the accompanying specification, in which:

FIG. 1 illustrates an exemplary motor drive in a drive-motor system to which the proposed method may be applied according to one or more embodiments;

FIG. 2 illustrates an exemplary model of a standstill induction motor that may be used in one or more embodiments of the present subject disclosure;

FIG. 3 illustrates an exemplary scheme for configuring a motor drive according to one or more embodiments of the present subject disclosure;

FIG. 4 illustrates an exemplary magnetic saturation model through four saturation model curves according to one or more embodiments;

FIG. 5 illustrates an exemplary fitting curve of a magnetic saturation model according to one or more embodiments;

FIG. 6a illustrates the magnetization of the main inductance L of an induction motor in which a DC current is injected according to one or more embodiments;

FIG. 6b illustrates the demagnetization of the main inductance L of the induction motor further to a DC current injection according to one or more embodiments;

FIG. 7 shows an exemplary voltage-time curve that illustrates a demagnetization process of a motor magnetic core of an induction motor;

FIG. 8a illustrates an exemplary conventional sequence of DC current injections;

FIG. 8b illustrates an exemplary improved sequence of DC current injections according to one or more embodiments;

FIG. 9 illustrates an apparatus according to one or more embodiments; and

FIG. 10 illustrates performances of a method for determining a rotor time constant of an electric motor.

### DETAILED DESCRIPTION

For simplicity and clarity of illustration, the drawing figures illustrate the general manner of construction, and descriptions and details of well-known features and techniques may be omitted to avoid unnecessarily obscuring the discussion of the described embodiments of the present subject disclosure. Additionally, elements in the drawing figures are not necessarily drawn to scale. For example, the dimensions of some of the elements in the figures may be exaggerated relative to other elements to help improve understanding of embodiments of the present subject disclosure. Certain figures may be shown in an idealized fashion in order to aid understanding, such as when structures are shown having straight lines, sharp angles, and/or parallel planes or the like that under real-world conditions would likely be significantly less symmetric and orderly. The same reference numerals in different figures denote the same elements, while similar reference numerals may, but do not necessarily, denote similar elements.

In addition, it should be apparent that the teaching herein can be embodied in a wide variety of forms and that any specific structure and/or function disclosed herein is merely representative. In particular, one skilled in the art will appreciate that an aspect disclosed herein can be implemented independently of any other aspects and that several aspects can be combined in various ways.

The present disclosure is described below with reference to functions, engines, block diagrams and flowchart illustrations of the methods, systems, and computer program according to one or more exemplary embodiments. Each described function, engine, block of the block diagrams and flowchart illustrations can be implemented in hardware, software, firmware, middleware, microcode, or any suitable combination thereof. If implemented in software, the functions, engines, blocks of the block diagrams and/or flowchart illustrations can be implemented by computer program instructions or software code, which may be stored or transmitted over a computer-readable medium, or loaded onto a general purpose computer, special purpose computer or other programmable data processing apparatus to produce a machine, such that the computer program instructions or software code which execute on the computer or other programmable data processing apparatus, create the means for implementing the functions described herein.

Embodiments of computer-readable media includes, but are not limited to, both computer storage media and communication media including any medium that facilitates transfer of a computer program from one place to another. As used herein, a “computer storage media” may be any physical media that can be accessed by a computer or a processor. In addition, the terms memory and computer storage media” include any type of data storage device, such as, without limitation, a hard drive, a flash drive or other flash memory devices (e.g. memory keys, memory sticks, key drive, SSD drives), CD-ROM or other optical storage, DVD, magnetic disk storage or other magnetic storage devices, memory chip(s), Random Access Memory (RAM), Read-Only-Memory (ROM), Electrically-erasable programmable read-only memory (EEPROM), smart cards, or any other suitable medium that can be used to carry or store program code in the form of instructions or data structures which can be read by a computer processor, or a combination thereof. Also, various forms of computer-readable media may transmit or carry instructions to a computer, including a router, gateway, server, or other transmission device, wired (coaxial cable, fiber, twisted pair, DSL cable) or wireless (infrared, radio, cellular, microwave). The instructions may comprise code from any computer-programming language, including, but not limited to, assembly, C, C++, Python, Visual Basic, SQL, PHP, and JAVA.

Unless specifically stated otherwise, it will be appreciated that throughout the following description discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

As used herein, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

Additionally, the word “exemplary” is used herein to mean “serving as an example, instance, or illustration”. Any embodiment or design described herein as “exemplary” is not necessarily to be construed as preferred or advantageous over other embodiments or designs.

In the present subject disclosure, the terms “coupled” and “connected”, along with their derivatives, may be indifferently used to indicate that two or more elements are in direct physical or electrical contact with each other, or two or more elements are not in direct contact with each other, but yet still co-operate or interact with each other.

It should be understood that embodiments of the present subject disclosure may be used for configuring an induction motor drive configured for driving an induction motor, in particular, although not limited to, an induction motor drive configured for driving an asynchronous induction motor.

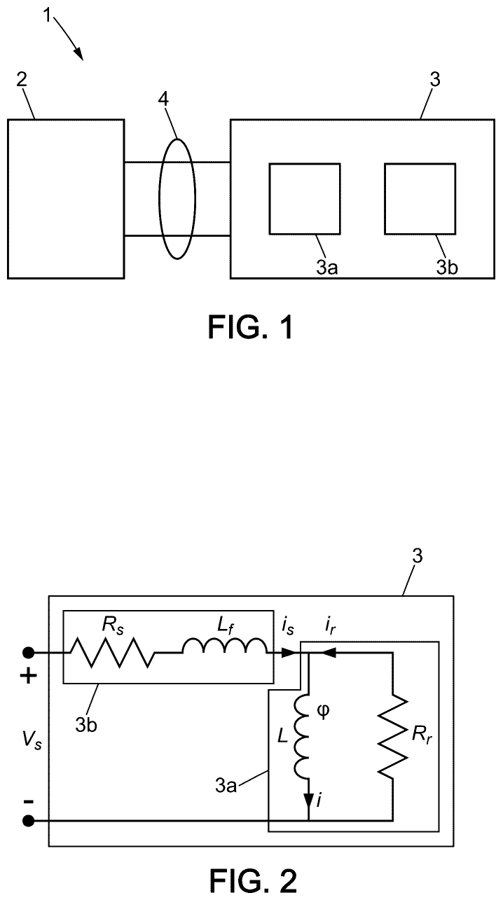

FIG. 1 shows an exemplary motor drive in a drive-motor system (1) to which the proposed methods may be applied according to one or more embodiments.

Shown on FIG. 1 is a drive-motor system (1) comprising a motor drive (2) and an induction motor (3) which are operatively coupled with each other through an interface (4).

The induction motor (3) comprises a rotor (3a) and a magnetic core (3b) which comprises a magnetic induction component (not shown on the figure), sometimes referred to as the “main induction” of the induction motor (3).

In some embodiments, a so-called “motor tuning” phase may be performed for determining configuration parameters of the motor drive (2) that corresponds to characteristics of the induction motor (3) so that the motor drive (2) be tuned for driving the induction motor (3).

Depending on the embodiment, the motor drive (2) may be implemented in software, as described above, or in hardware, such as an application specific integrated circuit (ASIC), or in the form of a combination of hardware and software, such as for example a software program intended to be loaded and executed on a component of FPGA (Field Programmable Gate Array) type.

As the proposed methods aim at being used for configuring an induction motor drive coupled to an induction motor at standstill, a model of a standstill induction motor may advantageously be considered.

FIG. 2 shows an exemplary model of a standstill induction motor that may be used in one or more embodiments of the present subject disclosure.

Shown on FIG. 2 is an exemplary inverse F-model of a standstill induction motor.

The standstill induction motor is modelled by a dipole circuit (3) to which a voltage Vs may be applied for starting the motor. The model includes a first block (3b) modelling a stator of the motor (3) which is serially coupled to a second block (3a) modelling a rotor of the motor (3). In the illustrated example of FIG. 1, the first block (3b) comprises a stator resistor Rₛ serially couple with a leakage inductance L_{f}, and the second block (3a) comprises rotor resistor Rᵣ coupled in parallel with a main inductance L of the motor (3).

As shown on FIG. 2, a current is that is injected in the motor (3) flows through the first block (3b), and then through the main inductance L of the motor (3). The current iₛ is summed with a current iᵣ that flows through the rotor resistance Rᵣ, resulting in a current i=iₛ+iᵣ (according to Kirchhoff's circuit law for currents flowing in and out a node of an electrical circuit) flowing through the main inductance L of the motor (3).

Assuming that the induction motor is at a standstill, the following sets of equations may be derived from the model of FIG. 2:

Equations along the d-axis:

$$\begin{matrix}{V}_{s d} = {R}_{s} {i}_{s d} + {L}_{f} \frac{d {i}_{s d}}{d t} + \frac{d {φ}_{d}}{d t} \\ 0 = {R}_{r} {i}_{r d} + \frac{d {φ}_{d}}{d t} \\ {φ}_{d} = L ( {i}_{s d} + {i}_{r d} )\end{matrix}$$

where V_{sd} is the projection on the d-axis of the input voltage Vₛ, Rₛ is the stator resistance, i_{sd} is the projection on the d-axis of a current iₛ injected to the motor, L_{f} is a leakage inductance of the stator, Rᵣ is the rotor resistance, i_{rd} is the projection on the d-axis of a current iᵣ flowing through the rotor resistance Rᵣ, and φ_{d} is the projection on the d-axis of the magnetic flux φ generated by the main inductance L of the rotor through which a current i=i_{sd}+i_{rd} flows.

Equations along the q-axis:

$$\begin{matrix}{V}_{s q} = {R}_{s} {i}_{s q} + {L}_{f} \frac{d {i}_{s q}}{d t} + \frac{d {φ}_{q}}{d t} \\ 0 = {R}_{r} {i}_{r q} + \frac{d {φ}_{q}}{d t} \\ {φ}_{d} = L ( {i}_{s q} + {i}_{r q} )\end{matrix}$$

where V_{sq} is the projection on the d-axis of the input voltage Vₛ, Rₛ is the stator resistance, i_{sq} is the projection on the d-axis of a current is injected to the motor, L_{f} is a leakage inductance of the stator, Rᵣ is the rotor resistance, i_{rq} is the projection on the d-axis of a current iᵣ flowing through the rotor resistance Rᵣ, and φ_{q} is the projection on the d-axis of the magnetic flux φ generated by the main inductance L of the rotor through which a current i=i_{sq}+i_{rq} flows.

As can be seen above, the equations along the d-axis and along the q-axis represent two identical systems, one along the d-axis and the other along the q-axis, evolving with no link between them. Each of these two systems can therefore be modelled as an inverse-F induction motor model, such as the exemplary model illustrated by FIG. 2.

As a consequence, the proposed scheme may be described using this exemplary model as applied for one or the other axis, so that the equations for one or the other axis may indifferently be used, as the proposed scheme may be used with either set of equations. In the following, as an example, the above set of equations corresponding to orienting the frame along the d-axis will be used, so that the model used can be narrowed down to one inverse-circuit.

In the following, the proposed scheme is described based on the exemplary model of an induction motor at standstill of FIG. 2 assuming a frame oriented along the d-axis. However, a person skilled in the art would understand that, even though the present description refers to the inverse F-model of a standstill induction motor with a frame oriented along the d-axis as an example of model of a standstill induction motor that may be used in one or more embodiments, the inverse F-model of a standstill induction motor with a frame oriented along the q-axis may be used in place of the inverse F-model of a standstill induction motor with a frame oriented along the d-axis, which is given by way of an example only.

Furthermore, in the following, the proposed scheme is described based on the exemplary model of an induction motor at standstill of FIG. 2. However, a person skilled in the art would understand that, even though the present description refers to the inverse Γ-model of a standstill induction motor as an example of model of a standstill induction motor that may be used in one or more embodiments, any other suitable model of a standstill induction motor may be used in place of the inverse Γ-model of a standstill induction motor of FIG. 2, which is given by way of an example only.

Referring back to FIGS. 1 and 2, in one or more embodiments, at least one configuration parameters for configuring the motor drive (2) for driving the induction motor (3) may be obtained through determining an estimate of the rotor resistance Rᵣ of the induction motor (3).

As a consequence, the proposed scheme advantageously provides a method for determining an estimate of the rotor resistance Rᵣ of the induction motor (3) while keeping the motor at standstill based on voltage measurements which may be performed with a standard-grade measurement equipment.

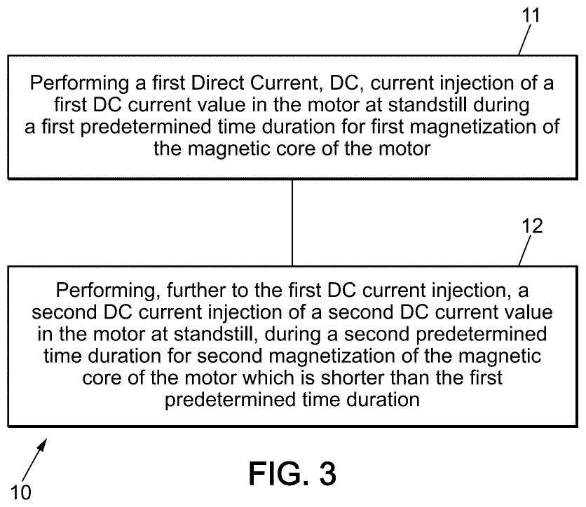

FIG. 3 is a diagram that illustrates an exemplary scheme (10) for configuring a motor drive according to one or more embodiments of the present subject disclosure.

One considers a motor drive coupled to an induction motor, such as illustrated on FIG. 1 for which data related to configuration parameters usable for configuring the motor drive for driving the motor may be determined according to the proposed scheme.

The motor to which the motor drive is coupled may in some embodiments be modeled by a standstill induction motor model such as described herein in relation with the example of FIG. 2.

Further, as illustrated in FIG. 1 and FIG. 2, the motor to be driven by the motor drive once configured may comprise a rotor and a magnetic core comprising a magnetic induction component.

In one or more embodiments, a first Direct Current, DC, current injection of a first DC current value in the motor at standstill may be performed (11) during a first predetermined time duration for (obtaining) a first magnetization of the magnetic core of the motor.

In some embodiments, the first DC current injection may be configured parameters comprising a first parameter related to the first DC current value and a second parameter related to the first predetermined time duration of the first DC current injection. The parameters of the first DC current injection may be set so that magnetic saturation of the magnetic core of the motor may be reached.

In one or more embodiments, further to (following) the first DC current injection (11), a second DC current injection of a second DC current value in the motor at standstill may be performed (12) during a second predetermined time duration for (obtaining) a second magnetization of the magnetic core of the motor, the second predetermined time duration being shorter than the first predetermined time duration.

In some embodiments, the motor drive may be configured based on the first and second DC current injections. For example, in some embodiments, as described in further details in the present disclosure, an estimate of a rotor resistance (Rᵣ) of the motor may be determined based on an estimate of the magnetic induction (L₀) of the motor and the rotor time constant (τ₀) (for example, in some embodiments, the estimate of the rotor resistance (Rᵣ) of the motor may be determined based on a ratio of an estimated magnetic induction (L₀) of the motor by the estimated rotor time constant (τ₀)), and the motor drive may be configured for driving the induction motor based on the estimate of the rotor resistance (Rᵣ) of the motor.

Advantageously, depending on the embodiment, only a first initial DC current injection or first and second initial DC current injections may be used to determine an estimate of the magnetic induction (L₀) of the motor and the rotor time constant (τ₀), so that subsequent DC current injections (that may be performed in some embodiments in order to determine an estimate of the magnetic induction (L₀) of the motor) may be (much) shorter than the initial DC current injection(s).

In some embodiments, one or more of the measurements of voltage may be performed during initial demagnetization of the magnetic core of the motor, that is, during an initial portion of the period of time during which a demagnetization phenomenon of the magnetic core occurs further to magnetization of the magnetic core at an initial magnetic flux value obtained by performing the first initial DC current injection.

In some embodiments, one or more of the measurements of voltage performed during their respective voltage measurement periods may comprise a plurality of S voltage measurement data points (vᵢ)_{1≤i≤s}, S being a non-zero natural integer.

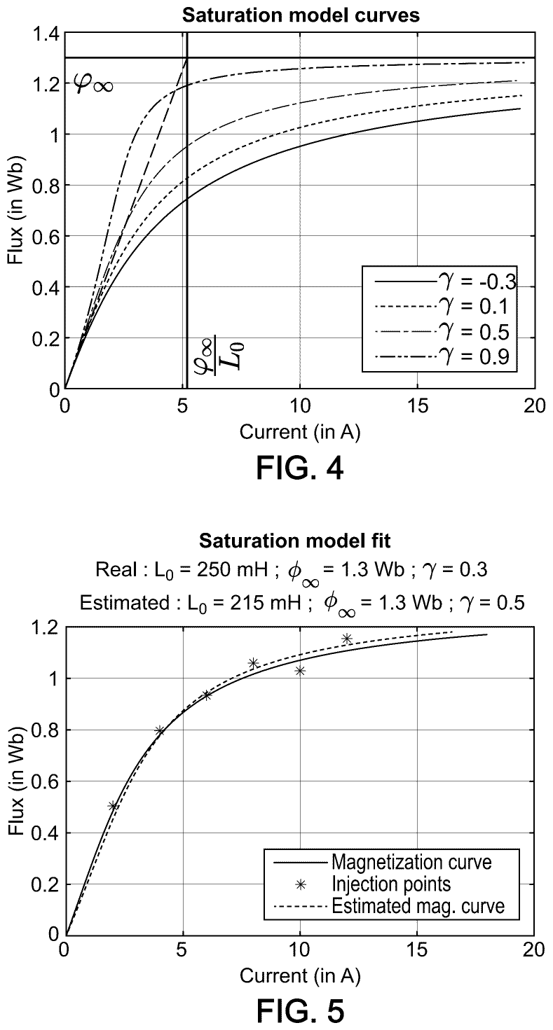

In one or more embodiments, magnetic saturation of the magnetic core of the motor to be driven further to injecting to the motor a DC current may be taken into account in the proposed scheme through the standstill induction motor model which has been chosen as model of the induction motor to be driven. For example, referring to FIG. 2, the main inductance L in the inverse-Γ model circuit shown on FIG. 2 may experience magnetic saturation, so that the magnetic flux of the magnetic core generated by injecting a DC current to the motor may increase, as the value of the injected current is increased, up to a certain ceiling value φ_{∞} which corresponds to a saturation magnetic flux value. That is, the relation between the current i inputted to the motor and the magnetic flux φ generated by the magnetic core of the motor is not linear for values beyond a certain injected current value, as illustrated in FIG. 4.

In one or more embodiments, a magnetic saturation model may therefore advantageously be considered in order to distinguish between the induction motor operating in linear regime (no magnetic saturation of the magnetic core), and the induction motor operating in saturation regime (occurrence of magnetic saturation of the magnetic core), for example to capture parameters or features of the motor operating in linear phase (linear regime), versus parameters or features of the motor operating in magnetic saturation phase (saturation regime). It is indeed advantageous to configure the drive so that the motor is driven with one or more current values which do not trigger magnetic saturation of the magnetic core of the motor.

In some embodiments, a magnetic core magnetization model that takes into account magnetic saturation of the core (sometimes referred herein to as a “magnetic saturation model”), which defines the relation between the current injected to the induction motor and the flux value in the main inductance of the induction motor may be considered to estimate parameters of the induction motor that characterize the motor operating in linear phase (linear regime) (versus the motor operating in magnetic saturation phase (saturation regime)).

For example, in some embodiments, the following magnetic saturation model i=f(φ) of an induction motor may be used for characterizing the motor operating in linear phase (linear regime):

$$i = \frac{φ}{{L}_{0}} \cdot \frac{1 - γ \frac{φ}{{φ}_{∞}}}{1 - {( \frac{φ}{{φ}_{∞}} )}^{2}}$$

where φ_{∞} designates the maximal magnetic flux that can be induced in the core (that may be seen as corresponding to the magnetic saturation flux generated by the main inductance assuming an infinite current injected in the motor), L₀ designates the linear inductance before saturation (that may be seen as corresponding to the value of the main inductance of the motor operating in linear phase (linear regime) (versus the motor operating in magnetic saturation phase (saturation regime))), and γ designates a unitless shape factor that impacts the flux value at which the magnetization switches from the linear regime to the saturated regime. The transition flux value may be equal to γφ_{∞} (γ<1).

The magnetic saturation model may therefore in some embodiments be a parametric model with three parameters (e.g., in the exemplary case of the above model: φ_{∞}, L₀, and γ).

FIG. 4 illustrates the magnetic saturation model through four saturation model curves respectively corresponding to four values of the γ parameter of the saturation model (the other two parameters having fixed values: φ_{∞}=1.3 Wb and L₀=250 mH.

In the following, the proposed scheme is described based on the exemplary parametric magnetic saturation model of an induction motor at standstill of FIG. 4 governed by the three parameters φ_{∞}, L₀, and γ. However, a person skilled in the art would understand that, even though the present description refers to the parameters of this exemplary magnetic saturation model, any other suitable magnetic saturation model of an induction motor, such as, for example, may be used in place of the parametric magnetic saturation model of an induction motor at standstill of FIG. 4, which is given by way of an example only.

In one or more embodiments, a plurality of N voltage measurements at motor terminals of the motor at standstill during demagnetization of the magnetic core of the motor may be used to determine an estimate of the parameters of the magnetic saturation model chosen for implementing the proposed scheme.

In one or more embodiments, for each of one or more of the plurality of N voltage measurements, a plurality of voltage data points may be measured during demagnetization of the magnetic core of the motor, further to performing a DC injection, that is, injecting a DC current in the motor at standstill for magnetizing the magnetic core to a so-called initial magnetic flux level. In some embodiments, a certain current may be injected for a given period of time in order to magnetize the inner core of the motor and, afterward, the circuit may be opened, and the voltage measurement performed on the open circuit. The induced voltage during demagnetization may be analyzed in order to obtain an estimate of the magnetic flux resulting from the DC injection. The determined estimate of the initial magnetic flux may be used in some embodiments for generating, for each of the one or more of the plurality of N voltage measurements, a duplet (i, φ), where i is the DC current that was injected in the motor for magnetizing the magnetic core, and p is the magnetic flux of the core resulting from the magnetization thereof.

For example, in embodiments in which the above described magnetic saturation model is used, a plurality of N voltage measurements at motor terminals of the motor at standstill during demagnetization of the magnetic core of the motor may be used to determine an estimate of the three parameters of this magnetic saturation model, as such model is governed by the three parameters φ_{∞}, L₀, and γ.

In one or more embodiments, the number N of voltage measurements performed for determining estimates of the parameters of the chosen magnetic saturation model may be chosen greater or equal to the number of magnetic saturation model parameters to be estimated.

In one or more embodiments, based on that the used magnetic saturation model is governed by three parameters, N may be chosen greater or equal to three (N≥3).

In some embodiments, each of the voltage measurements is performed during a demagnetization of the magnetic core of the motor, further to injecting a current in the motor at standstill for magnetizing the magnetic core.

For example, each of the N voltage measurements (Vₛⱼ)_{1≤j≤N} may be preceded by a DC current injection iⱼ of respective level, so that N duplets (iⱼ,Vₛⱼ)_{1≤j≤N} of injected DC current value and measured voltage value may be determined.

In one or more embodiments, each voltage measurement Vₛⱼ may further be used to determine a corresponding magnetic flux value φⱼ of magnetic flux in the main inductance of the motor, so that N magnetic flux values (φⱼ)_{1≤j≤N} may be determined based on the N voltage measurements (Vₛⱼ)_{1≤j≤N}.

In some embodiments, the N magnetic flux values (φⱼ)_{1≤j≤N} may be used to determining a plurality of N duplets (iⱼ, φⱼ)_{1≤j≤N} of injected DC current and magnetic flux values, based on the N voltage measurements (Vₛⱼ)_{1≤j≤N} performed further to injecting respective values i of DC current in the motor at standstill for respective time periods.

In some embodiments, the plurality of N duplets (iⱼ, φⱼ)_{1≤j≤N} injected DC current and magnetic flux values may be used as N injection points (iⱼ, φⱼ)^{1≤j≤N} that may advantageously be used to determine a best fitting saturation curve of the chosen magnetic saturation model.

Depending on the embodiment, any suitable fitting method may be used to fit the magnetic saturation model to the experimental data (injection points (iⱼ, φⱼ)_{1≤j≤N}). For example, if more than N (e.g. N=3) injection points are used to fit a magnetic saturation model governed by N parameters, a least-square method may be applied to fit the model on the experimental data.

In some embodiments, a linear regression algorithm may be applied to fit the magnetic saturation model on the N injection points (iⱼ, φⱼ)_{1≤j≤N} in order to determine respective estimates of the parameters corresponding to the linear regime of the saturation model.

In one or more embodiments, the equation i=f(φ) defining the magnetic saturation model may be reformulated in a linear way in order to apply a linear regression algorithm on the measurement data (N injection points (iⱼ, φⱼ)_{1≤j≤N}).

For example, the equation

$$i = \frac{φ}{{L}_{0}} \cdot \frac{1 - γ \frac{φ}{{φ}_{∞}}}{1 - {( \frac{φ}{{φ}_{∞}} )}^{2}}$$

may be reformulated as follows:

$$i = \frac{1}{{L}_{0}} φ - \frac{γ}{{L}_{0} {φ}_{∞}} {φ}^{2} + \frac{1}{{φ}_{∞}^{2}} i {φ}^{2}$$

So that the three coefficients

$$\frac{1}{{L}_{0}} , - \frac{γ}{{L}_{0} {φ}_{∞}} , and \frac{1}{{φ}_{∞}^{2}}$$

may be estimated in order to determine an estimate of three parameters φ_{∞}, L₀, and γ.

In embodiments where a linear regression algorithm is used on the N injection points, the following matrices A and B may be computed for performing the linear regression:

$$A = [ \begin{matrix}{Σφ}_{j}^{2} & {Σφ}_{j}^{3} & Σ {i}_{j} {φ}_{j}^{3} \\ {Σφ}_{j}^{3} & {Σφ}_{j}^{4} & Σ {i}_{j} {φ}_{j}^{4} \\ Σ {i}_{j} {φ}_{j}^{3} & Σ {i}_{j} {φ}_{j}^{4} & Σ {i}_{j}^{2} {φ}_{j}^{4}\end{matrix} ]$$

$$and$$

$$B = [ \begin{matrix}Σ {i}_{j} {φ}_{j}^{3} \\ Σ {i}_{j} {φ}_{j}^{3} \\ Σ {i}_{j}^{2} {φ}_{j}^{2}\end{matrix} ]$$

where the respective matrix sizes of A and B are determined by 1≤j≤N.

In some embodiments, the matrix product A⁻¹·B of the inverse of matrix A by matrix B may be determined in order to obtain an estimate the three coefficients

$$\frac{1}{{L}_{0}} , - \frac{γ}{{L}_{0} {φ}_{∞}} , and \frac{1}{{φ}_{∞}^{2}} ,$$

as:

$${A}^{- 1} \cdot B = [ \begin{matrix}\frac{1}{{L}_{0}} \\ - \frac{γ}{{L}_{0} {φ}_{∞}} \\ \frac{1}{{φ}_{∞}^{2}}\end{matrix} ]$$

In one or more embodiments, in order to calculate each of the three elements of the vector resulting from the matrix product A⁻¹·B, the matrix determinant of matrix A may be computed, based on which the following three matrix determinants may be computed:

$$\vert A \vert = \vert \begin{matrix}{Σφ}_{j}^{2} & {Σφ}_{j}^{3} & Σ {i}_{j} {φ}_{j}^{3} \\ {Σφ}_{j}^{3} & {Σφ}_{j}^{4} & Σ {i}_{j} {φ}_{j}^{4} \\ Σ {i}_{j} {φ}_{j}^{3} & Σ {i}_{j} {φ}_{j}^{4} & Σ {i}_{j}^{2} {φ}_{j}^{4}\end{matrix} \vert$$

$$\frac{1}{{L}_{0}} = \frac{1}{\vert A \vert} \times \vert \begin{matrix}Σ {i}_{j} {φ}_{j} & {Σφ}_{j}^{3} & Σ {i}_{j} {φ}_{j}^{3} \\ Σ {i}_{j} {φ}_{j}^{2} & {Σφ}_{j}^{4} & Σ {i}_{j} {φ}_{j}^{4} \\ Σ {i}_{j}^{2} {φ}_{j}^{2} & Σ {i}_{j} {φ}_{j}^{4} & Σ {i}_{j}^{2} {φ}_{j}^{4}\end{matrix} \vert$$

$$- \frac{γ}{{L}_{0} {φ}_{∞}} = \frac{1}{\vert A \vert} \times \vert \begin{matrix}{Σφ}_{j}^{2} & Σ {i}_{j} {φ}_{j} & Σ {i}_{j} {φ}_{j}^{3} \\ {Σφ}_{j}^{3} & Σ {i}_{j} {φ}_{j}^{2} & Σ {i}_{j} {φ}_{j}^{4} \\ Σ {i}_{j} {φ}_{j}^{3} & Σ {i}_{j}^{2} {φ}_{j}^{2} & Σ {i}_{j}^{2} {φ}_{j}^{4}\end{matrix} \vert$$

$$\frac{1}{{φ}_{∞}^{2}} = \frac{1}{\vert A \vert} \times \vert \begin{matrix}{Σφ}_{j}^{2} & {Σφ}_{j}^{3} & Σ {i}_{j} {φ}_{j} \\ {Σφ}_{j}^{3} & {Σφ}_{j}^{4} & Σ {i}_{j} {φ}_{j}^{4} \\ Σ {i}_{j} {φ}_{j}^{3} & Σ {i}_{j} {φ}_{j}^{4} & Σ {i}_{j}^{2} {φ}_{j}^{2}\end{matrix} \vert$$

Based on the above matrix determinants, respective estimates of the magnetic saturation model parameters L₀, φ_{∞}, and γ may be calculated.

In particular, in some embodiments, an estimate of the magnetic inductance component L₀ of the motor operating in linear regime may be determined based on one or more of the above matrix determinants, the elements of which may have been determined based on the N voltage measurements performed on the motor at standstill.

FIG. 5 illustrates an exemplary fitting curve of a magnetic saturation model calculated based on magnetic saturation model parameters estimated based on a plurality of six injection points respectively corresponding to six current-flux duplets (iⱼ, φⱼ)_{1≤j≤6}.

Shown on FIG. 5 are the injection points (iⱼ, φⱼ)_{1≤j≤6}, the magnetization curve of the magnetic saturation model, and the estimated magnetization curve based on which the parameters L₀, φ_{∞}, and γ of the model can be calculated. In the illustrated example of FIG. 5, the theoretical values of the magnetic saturation model parameters are: L₀=250 mH, φ_{∞}=1.3 Wb, and γ=0.3, and the values of the estimated using the proposed saturation model fit method are: L₀'2 215 mH, φ_{∞}=1.3 Wb, and γ=0.5.

Therefore, in one or more embodiments, an estimate of one or more parameters of the magnetic saturation model of the magnetic inductance of the motor may be determined based on the plurality of N duplets of current and magnetic flux values (iⱼ,φⱼ)_{1≤j≤N}.

In one or more embodiments, a plurality of N respective Direct Current, DC, current injections in the motor at standstill may be performed prior to performing the plurality of N respective voltage measurements, for magnetization of the magnetic core of the motor before opening the electrical circuit of the motor and performing the voltage measurement on the open circuit (at the motor's terminals) during demagnetization of the magnetic core.

For example, in some embodiments, each of the N voltage measurements at motor terminals of the motor at standstill during demagnetization of the magnetic core of the motor may be performed following a DC current injection of a respective value of DC current in the motor at standstill performed for a respective DC injection time duration, so that the magnetic core of the motor may be magnetized to an initial magnetic flux when the N voltage measurements is performed.

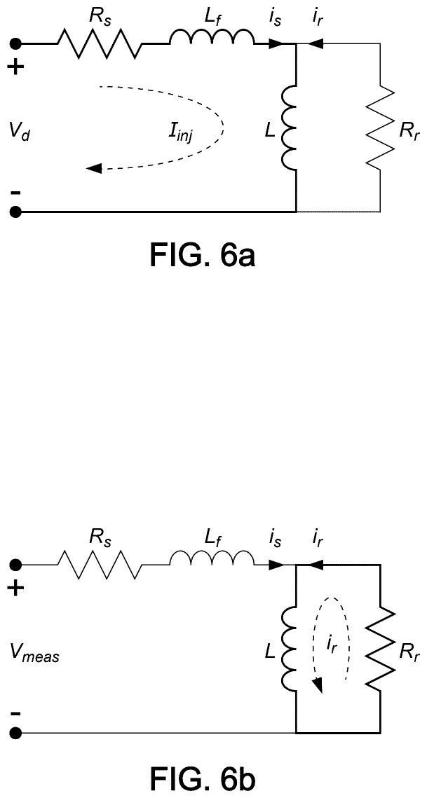

In some embodiments, N DC current injections may be performed at respective levels (iⱼ)_{1≤j≤N} for a respective time period (Δtⱼ)_{1≤j≤N} so that the magnetic core of the motor may be magnetized at a certain level, as illustrated by FIG. 6a.

FIG. 6a shows the injection of a DC current Iᵢₙⱼ in an induction motor (modeled by the exemplary inverse-Γ model of the induction motor at standstill illustrated by FIG. 2) in order to generate magnetization of the main inductance L of the motor, that is, to generate an initial magnetic flux in the main inductance L of the motor. During the DC current injection, the main inductance L of the motor becomes magnetized at a magnetic flux level which depends on one or more of the level of the injected DC current and the duration of the DC current injection.

Referring to FIG. 2 and FIG. 6a, during injection of the DC current Iᵢₙⱼ in the motor, a current iₛ may flow in the serially coupled stator resistance Rₛ and leakage inductance L_{f} block (3b in FIG. 2) and the main inductance L of the motor, and no current may flow in the rotor resistance Rᵣ of the motor. When imposing a constant voltage on the motor's terminals, the input current may eventually stabilize in the main inductance L after a certain time period.

In some embodiments, different levels of DC current (i)_{1≤j≤N} may be injected in the motor so that respective different levels of magnetic flux (φⱼ)_{1≤j≤N} may be generated at the main inductance L (magnetic core) of the motor.

In one or more embodiments, once a DC current injection is stopped, the electrical circuit of the motor may be opened at the positive and negative poles, and the voltage Vₘₑₐₛ at the motor terminals corresponding to the poles of the motor at standstill may be measured.

FIG. 6b shows the demagnetization of the main inductance L of the motor (modeled by the exemplary inverse-Γ model of the induction motor at standstill illustrated by FIG. 2) once the DC current Iᵢₙⱼ is no longer injected and the circuit of the motor is opened.

Referring to FIG. 2 and FIG. 6b, once the DC current Iᵢₙⱼ is no longer injected in the motor and the circuit is opened, the current iₛ may no longer flow in the serially coupled stator resistance Rₛ and leakage inductance L_{f} block (3b in FIG. 2) and the main inductance L of the motor, and a current iᵣ (induced by the magnetized magnetic core of the motor) may instead flow in the parallel coupled rotor resistance Rᵣ and main inductance L of the motor. Once the circuit is opened, a demagnetization process starts between the main inductance L and the rotor resistance Rᵣ from the initial magnetic flux (which corresponds to the magnetic flux level that was reached by magnetization of the core, e.g. through a prior DC injection). At this point, the measured voltage Vₘₑₐₛ corresponds to the voltage across the main inductance L because no current is flowing through the stator resistance Rₛ and the leakage inductance L_{f}:

$${V}_{meas} ( t ) = \frac{d φ}{dt} ( t )$$

A voltage measurement Vₘₑₐₛ of the voltage at the terminals of the motor may therefore advantageously reflect the magnetic flux φ of the main inductance L of the motor.

During the demagnetization process, the magnetic flux in the motor magnetic core may be governed by the following differential equation:

$$0 = {R}_{r} \frac{φ ( t )}{{L}_{0}} \frac{1 - γ \frac{φ ( t )}{{φ}_{∞}}}{1 - {( \frac{φ ( t )}{{φ}_{∞}} )}^{2}} + \frac{d φ}{dt} ( t )$$

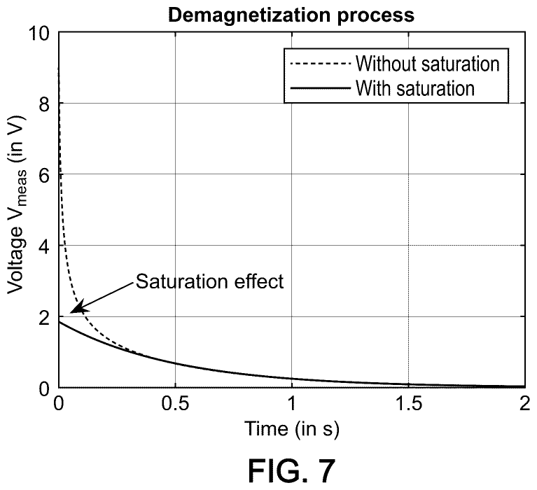

FIG. 7 shows a voltage-time curve that illustrates a demagnetization process of a motor magnetic core. The exemplary curve of FIG. 7 showing the evolution of the measured voltage over time during demagnetization of the magnetic core of the motor.

FIG. 7 shows an exemplary demagnetization curve for the following parameters of the exemplary induction motor model and exemplary magnetic saturation model discussed herein: γ=0.3, φ_{∞}=1.3 Wb, L₀=250 mH, Rᵣ=500 mΩ, and for an initial magnetic flux value of φ(0)=1.17 Wb.

As shown by FIG. 7, a magnetic saturation effect of the magnetic core of the motor may be reflected in the beginning of the demagnetization process of the core as the magnetic core may have reached its saturation level during the magnetization process. As a consequence, the measured voltage may decrease linearly over time from an initial value, whereas it would exponentially decrease over time without saturation of the magnetic core, as illustrated by FIG. 7.

As shown on FIG. 7, the saturation effect is reflected on the measured voltage for an initial period of time of approximately half a second (tₛₐₜ≈0.5 s), whereas the measured voltage may accurately reflect the demagnetization process without saturation afterwards (from tₛₐₜ to the end of the demagnetization of the core). That is, assuming that the demagnetization process lasts a given demagnetization duration (Δt_{Demag} being equal to approximately 2 seconds in the example illustrated by FIG. 7), the saturation effect occurring during magnetization of the magnetic core may be reflected in the voltage measurement part performed the early part of the demagnetization duration (Δt_{Demag}) (from t=0 to t=tₛₐₜ in the example of FIG. 7), while it would no longer be present in a voltage measurement part performed for the rest of the demagnetization process (from tₛₐₜ to the end of Δt_{Demag}).

Various methods may be used to estimate the value of the magnetic flux of the core of the motor once magnetized further to a DC current injection which corresponds to each of one or more of the plurality of N voltage measurements. For example, an integration analysis voltage measurement processing method may be used to integrate the value(s) of the measured voltage over the time period during which the corresponding voltage measurements are performed, which may result in a first magnetic flux estimate component. As another example, an exponential regression analysis voltage measurement processing method may be used to fit an exponential decreasing curve on the voltage measurement.

In one or more embodiments, a hybrid method which uses both the integration method and the exponential regression analysis method, may be used, which advantageously exploits the fact that the magnetic saturation of the core is reflected in the voltage measurement only for an early portion of the demagnetization process, while the voltage decreases according to an exponential decay curve reflecting demagnetization after the end of the early portion and until the end of the demagnetization process.

In such embodiments, two successive time periods of the demagnetization process may therefore be distinguished with respect to presence of the magnetic saturation effect reflected in the voltage measurement: a first, initial, time period at the beginning of demagnetization during which it can be considered that the measured voltage is impacted by the magnetic saturation of the core, and a second, subsequent, time period following the first time period until the end of demagnetization during which it can be considered that the measured voltage is no longer impacted by the magnetic saturation of the core. In the following, the first time period may be referred to as “first time period showing saturation”, while the second time period may be referred to as “second time period without saturation.”

In one or more embodiments, instead of using an integration method until the end of the demagnetization process, that is, until the end of the demagnetization duration (Δt_{Demag}), which would require performing the voltage measurement by collecting voltage measurement data points for the entire demagnetization duration (Δt_{Demag}) in order to estimate the initial magnetic flux of the magnetic core by integrating the value of the measured induced voltage until the end of the demagnetization process (e.g. integrating the collected voltage data points over the entire demagnetization duration (Δt_{Demag})), the integration method may be used only during the first time period showing saturation.

In some embodiments, the integration method may be used on a voltage measurement that is only performed during a voltage measurement period during initial demagnetization of the magnetic core of the motor. The voltage measurement period during which the voltage measurement is performed may be preconfigured to correspond to the specific first time period showing saturation of the motor on which the voltage measurement is performed. As a consequence, the voltage measurement may advantageously not be performed until the end of the demagnetization process, but instead only during a voltage measurement period which corresponds to an initial portion of the demagnetization process, and is shorter than the entire demagnetization process.

Advantageously, because the voltage measurement may not be performed until the end of the demagnetization process, only the first initial DC current injection (or, depending on the embodiment, the first and second DC current injection) may be configured in duration such that the magnetic core of the motor is fully magnetized, and such constraint may not be complied with for subsequent DC current injections. The first and second initial DC current injections may be spaced apart in time by a time period chosen sufficiently long for demagnetization of the magnetic core to occur, so that the rotor time constant (τ₀) may be estimated during such demagnetization (for example as described in the present subject disclosure). Advantageously, once initial DC current injection(s) have been performed as configured for estimating the rotor time constant (τ₀), the subsequent DC current injections may be configured much shorter in time as well as, in some embodiments, much less spaced apart, thereby greatly shortening the entire sequence of DC current injections. In some embodiments, the first initial DC current injection may be configured (in one or more of time duration and value) so that it performs (full) magnetization of the magnetic core of the motor. For example, the first initial magnetization may be performed during a first initial time duration in seconds, such as 2 seconds, with a first DC current value (which may be chosen as the maximum value of all of the DC current injections performed for configuring the drive).

Once magnetization of the magnetic corer has been achieved, a determination of an estimate of the rotor time constant (τ₀) may be performed, during a demagnetization time period sufficient for determining this estimate (which may depend on the method used for determining such estimate) during demagnetization of the core.

Further to the demagnetization time period, as the core is demagnetized, a second initial DC current injection may be performed during a second initial time duration (which may be chosen substantially equal to the first initial time duration, for example 2 seconds), with a second DC current value (typically chosen different from the first DC current value). In embodiments in which the first DC current value is the maximum value of all the respective DC current values of all of the DC current injections performed for configuring the drive, the second DC current value may be chosen inferior to the first DC current value (so that the first and second DC current value are not equal) while sufficiently high so that magnetization of the core is obtained through the second initial DC current value.

At this stage of the sequence of DC current injections, because demagnetization that occurred between the first initial DC current injection and the second initial DC current injection was advantageously used for determining an estimate of the rotor time constant (τ₀), subsequent DC current injections may be performed with different respective DC current values (e.g. following a sequence of decreasing DC current values) without waiting for a demagnetization of the core in between two DC current injections, in order to benefit from the only partial demagnetization of the core in the shortened time interval in-between two successive DC current injections, thereby leading to an entire sequence of DC current injections of shortened time duration, yet advantageously usable for computing various parameters necessary for configuring the motor drive.

In some embodiments, the voltage measurement may be configured to be started during an initial phase of the demagnetization process (at an early stage of demagnetization), and to end before the end of the demagnetization process. The voltage measurement may therefore result in voltage measurement data points covering only an initial portion of the demagnetization process (at an early stage of demagnetization).

As a consequence, the integration method applied on the voltage measurement (data points) may result in integrating the measured induced voltage over a period of time spanning an initial time at which the voltage measurement starts to the end of the voltage measurement period, instead of integrating the measured voltage until the end of demagnetization.

Depending on the embodiments, the voltage at the motor's terminals may or not be measured until the end of the demagnetization process, so that voltage measurement data points that may have been acquired after the end of the voltage measurement period may be disregarded for purposes of applying the integration method. As a consequence, only the voltage measurement data points acquired during the voltage measurement period may be used for purposes of applying the integration method.

Referring back to FIG. 7, using only voltage measurement data points acquired during a voltage measurement period configured during initial demagnetization of the magnetic core of the motor (at an early stage of the demagnetization process of the core) for applying the integration method is advantageous in that it avoids applying such integration method to voltage values which, because the reflect a latter part until the end of the demagnetization of the core, may be low and subject to unprecise measurements depending on the measurement equipment used for performing the voltage measurement (for example in cases where a standard-grade voltage measurement equipment with limited accuracy performances for low voltage values is used). Indeed, performing the voltage measurement with limited accuracy would generate errors when applying the integration method which may build up during the magnetic decaying, with a resulting error which is proportional to the integration duration. An advantage of the proposed scheme is therefore to avoid using the integration method over an integration duration which is too long in that it uses measured data points that correspond to the early stage of the demagnetization and therefore may not suffer from measurement errors that would be detrimental to the accuracy of the estimate obtained with the integration method. By using the integration method only on voltage measurement data points captured during an initial part (early stage) of the demagnetization process, the captured values can be considered high enough so that measurement errors are avoided, or at least reduced, even in cases of using a standard-grade measurement equipment.

In one or more embodiments, because the integration method is used only on the voltage measurement data points acquired during a voltage measurement period which is shorter than the entire demagnetization process duration, it may result in a magnetic flux estimate which is a component of the magnetic flux that would be estimated if the integration method had been applied over the entire demagnetization process duration. As a consequence, a first magnetic flux estimate component may be determined based on the voltage measurement, for example by using the integration method applied to voltage measurement data points acquired during the voltage measurement period.

In some embodiments, the integration method may be used for integrating the voltage measurement over the voltage measurement period, in order to integrate the value of the measured voltage induced by the demagnetization until the end of the voltage measurement period, which advantageously falls before the end of the demagnetization process.

In some embodiments, the measurement of the voltage for the voltage measurement period for each of one or more of the plurality of N voltage measurements may comprise a plurality of S voltage measurement data points (vᵢ)_{1≤i≤S}, S being a non-zero natural integer, and one or more of the plurality of S voltage measurement data points (vᵢ)_{1≤i≤S} may be integrated in order to obtain the first magnetic flux estimate component.

For example, in embodiments where the S voltage measurement data points (vᵢ)_{1≤i≤S} are obtained through measurement sampling with a sampling interval (Δt), the first magnetic flux estimate component may be determined based on a combination of the sampling interval with a combination of one or more of the S voltage measurement data points (vᵢ)_{1≤i≤S}, such as, for example, the combination Δt·Eᵢ₌₁^{S}vᵢ.

According to the present subject disclosure, a second method, other than the integration method, may be used for determining the portion of the initial magnetic flux which is not accounted for by integrating the induced voltage only on a portion of the demagnetization process duration. In one or more embodiments, a regression method (e.g. an exponential regression method) may be used for that purpose. Using an exponential regression method is advantageous in the exemplary context of the present subject disclosure focusing on the demagnetization process of the magnetic core of an induction motor in that such demagnetization process typically follows an exponential decaying profile, such as the one illustrated by FIG. 7.

As discussed above, during the demagnetization process, the magnetic flux in the motor magnetic core may be governed by the following differential equation:

$$0 = {R}_{r} \frac{φ ( t )}{{L}_{0}} \frac{1 - γ \frac{φ ( t )}{{φ}_{∞}}}{1 - {( \frac{φ ( t )}{{φ}_{∞}} )}^{2}} + \frac{d φ}{dt} ( t )$$

In some embodiments, small values of magnetic flux (φ(t)<<φ_{∞}) may be considered in order to approximate the magnetization as linear, thereby leading to the following simplified formulation of the above differential equation:

$$0 = {R}_{r} \frac{φ ( t )}{{L}_{0}} + \frac{d φ}{dt} ( t )$$

as

$$1 - γ \frac{φ ( t )}{{φ}_{∞}} \approx 1 and 1 - {( \frac{φ ( t )}{{φ}_{∞}} )}^{2} \approx 1.$$

The following function φₐ(t) is a solution to the above simplified equation:

$${φ}_{a} ( t ) = {φ}_{a} ( {t}^{′} ) {e}^{- \frac{t - t ′}{{τ}_{0}}}$$

where

$${τ}_{0} = \frac{{L}_{0}}{{R}_{r}}$$

is the rotor time constant of the rotor of the motor operating in linear regime. The magnetic flux of the magnetic core of an injection motor may therefore decrease exponentially during demagnetization, the exponential decrease being governed by a time constant τ₀ that corresponds to the rotor time constant of the rotor of the motor operating in linear regime.

Therefore, in some embodiments, N DC voltage measurements at the motor's terminals during demagnetization of the magnetic core of the motor (which may in some embodiments respectively correspond to N DC current injections) can be advantageously used for two different purposes:

First, as discussed above, an estimate of the magnetic induction of the motor operating in linear phase L₀ may be determined based on the N voltage measurements, for example through a saturation model fit method exploiting N data points (iⱼ,φⱼ)_{1≤j≤N} determined based on the N voltage measurements: by realizing DC current injections at different levels, each injection may advantageously provide, after integrating

$${V}_{meas} ( t ) = \frac{d φ}{dt} ( t ) ,$$

the value of the flux in the main inductance L.

For example, in one or more embodiments, one or more of the N measured voltages (at motor terminals of the motor at standstill during demagnetization of the magnetic core of the motor) may be integrated over time to determine respective estimates (φⱼ) of the magnetic flux in the magnetic core of the motor (e.g. the main inductance L of FIG. 2):

$${φ}_{j} = \int {V}_{meas , j} ( t ) dt = \int \frac{d φ}{dt} ( t ) dt$$

where V_{meas,j}(t) is a j-th voltage measured at terminals of the motor at standstill during demagnetization of the magnetic core of the motor, which may be following a j-th DC current injection iⱼ to the motor for magnetizing the magnetic core.

In some embodiments, a plurality of N data points (iⱼ, φⱼ)_{1≤j≤N} may be determined further to determining a j-th estimated magnetic flux φⱼ that corresponds to a j-th DC current injection iⱼ, where the j-th magnetic flux in the magnetic core is estimated based on a j-th voltage measured at terminals of the motor at standstill during demagnetization of the magnetic core of the motor following the j-th DC current injection iⱼ to the motor for magnetizing the magnetic core.

In some embodiments, the plurality of N data points (iⱼ, φⱼ)_{1≤j≤N} may be used to apply a fitting algorithm of a magnetic saturation model, such as for example the linear regression described above for the above-mentioned exemplary magnetic saturation model, in order to estimate a set of one or more of the parameters of the magnetic saturation model that includes an estimate of the magnetic inductance (L₀) of the motor operating in linear regime.

In one or more embodiments where the hybrid method for determining an estimate of the magnetic flux of the magnetic core further to magnetization through a DC current injection is used, using the exponential regression method may involve fitting an exponential decreasing curve on the voltage measurement data points acquired during the voltage measurement period.

A second magnetic flux estimate component can then advantageously be deduced mathematically from the resulting fitted parameters.

Use of the exponential regression method is advantageous because this method is immune from measurement errors as it forces the voltage curve to fit a perfect exponential curve. However, the exponential regression method assumes magnetic linearity and tends to perform badly under magnetic saturation.

The exponential regression method is therefore a good complement to the integration method as it performs well for voltage measurement values for which the integration method does not (as the integration method is sensitive to measurement errors potentially made when measuring small voltage values at the end of the demagnetization process), and vice versa (as the exponential regression method leads to errors during the initial (early) phase of demagnetization where magnetic saturation of the magnetic core is present).

Therefore, in some embodiments, the integration method may be used for determining a first magnetic flux estimate component based on a voltage measurement performed only on a portion of the demagnetization process of the magnetic core of an induction motor, and the exponential regression method may be used for determining a second magnetic flux estimate component which, combined with the first magnetic flux estimate component, will provide an estimate of the magnetic flux of the magnetic core at the start of demagnetization.

As the voltage measurement data points of a voltage measurement may be used for performing the integration method only for an early portion of the demagnetization process (the remainder of the demagnetization curve being estimated using the exponential regression analysis method), using the hybrid method advantageously allows not to wait for complete demagnetization of the magnetic core of the motor further to a DC current injection.

As a consequence, in one or more embodiments, the duration of subsequent DC current injections may be configured shorter than that of the initial DC current injection(s), which advantageously leads to a faster tuning procedure using DC current injections.

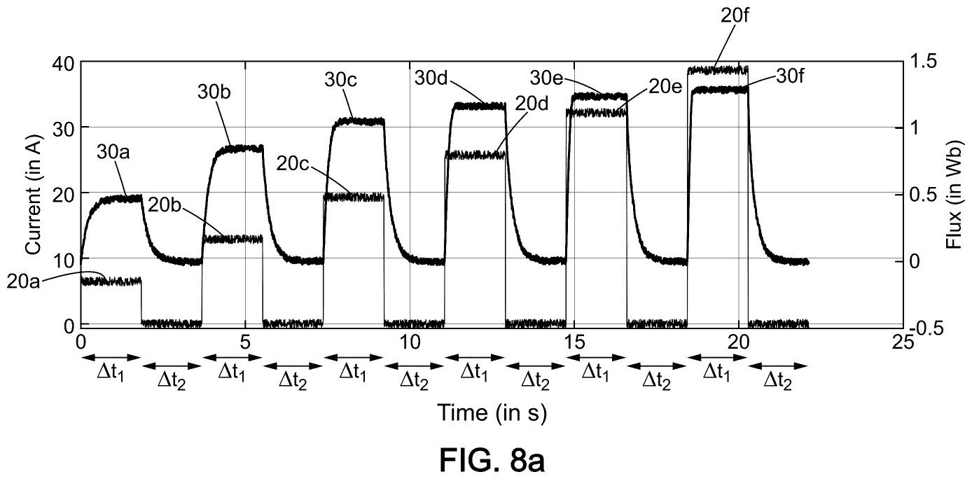

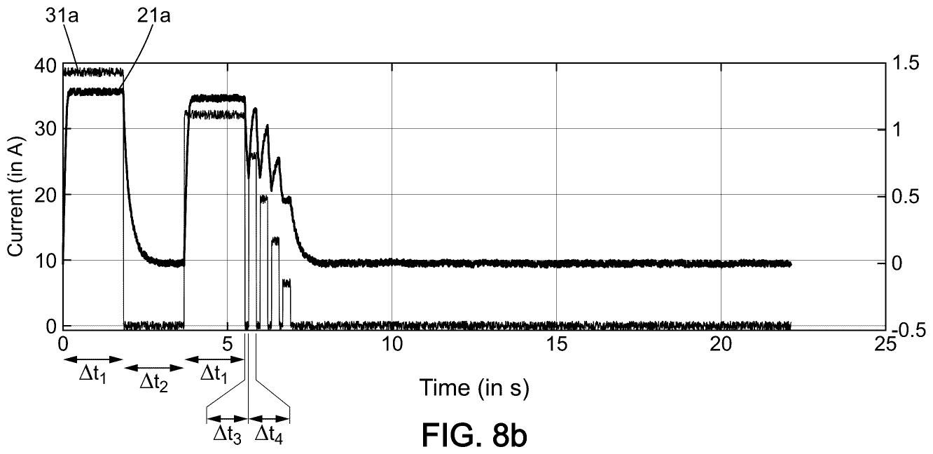

FIG. 8a shows a conventional sequence of DC current injections and corresponding magnetization/demagnetization profiles of the magnetic core of the motor.

As shown on FIG. 8a, a sequence of DC current injections (20a-20f) of substantially equal durations Δtᵢ, spaced by a substantially constant duration Δt₂, and of increasing DC current values may be performed in order to achieve a plurality of voltage measurements during respective demagnetization phases of the magnetic core of the motor.

FIG. 8a also illustrates exemplary magnetic flux (30a-30f) that may successively be induced in the magnetic core of the motor by the DC current injections: Each of the DC injections induces a corresponding magnetic flux in the magnetic core of the motor. The substantially constant time duration Δtᵢ of the DC current injections may be chosen so as to ensure that the magnetic core of the motor reaches magnetic saturation given the respective DC current injection value of each current injection.

In the example of FIG. 8a, the time duration of the smallest DC current injection value, which corresponds to the first DC current injection (20a), may be chosen so as to ensure that the magnetic core of the motor reaches magnetic saturation given that the value of this DC current injection is the smallest of all DC current injections. Further, the respective time durations of the other DC current injections may be chosen equal or greater than the time duration chosen for the DC current injection (20a) of the smallest DC current injection value. As shown on FIG. 8a, these time durations may be chosen substantially equal, for example to the time duration chosen for the DC current injection (20a) of the smallest DC current injection value.

FIG. 8a also illustrates the successive demagnetizations of the magnetic core of the motor through respective decays of each of the exemplary magnetic flux (30a-30f) successively induced in the magnetic core of the motor by the DC current injections, for a time period Δt₂ after the end of the previous DC current injection. The duration of the time period Δt₂ in-between two successive DC current injections may be chosen so as to ensure a complete demagnetization of the magnetic core of the motor, further to the magnetization that was induced by the DC current injection.

As shown in FIG. 8a, two successive DC current injections may be spaced by a substantially constant time period Δt₂, which may be chosen so as to ensure complete demagnetization of the magnetic core of the motor. In the example of FIG. 8a, the time duration following the greatest DC current injection value, which corresponds to the last DC current injection (20f), may be chosen so as to ensure that the complete demagnetization of the magnetic core of the motor. Further, the respective time durations following the other DC current injections may be chosen equal or greater than the time duration chosen with respect to the DC current injection (20f) of the greatest DC current injection value. As shown on FIG. 8a, these time durations may be chosen substantially equal, for example to the time duration Δt₂ chosen for the DC current injection (20f) of the greatest DC current injection value.

As a result, the exemplary conventional sequence of DC current injections of FIG. 8a may have a total duration of 6×Δtᵢ+5×Δt₂. More generally, a conventional sequence of n DC current injections may last a total of n×Δt₁+(n−1)×Δt₂, where Δt₁ is the time duration of each DC current injection of the sequence, Δt₂ is the time duration during which there is no DC current injection following a DC current injection, and n is a non-null natural integer corresponding to the total number of DC current injections performed on the motor.

FIG. 8b shows an improved sequence of DC current injections and corresponding magnetization/demagnetization profiles of the magnetic core of the motor according to one or more embodiments.

As shown on FIG. 8b, an improved sequence of DC current injections (21a-21f) may be performed in some embodiments.

In some embodiments, the improved sequence of DC current injections may comprise a first DC current injection (21a) of a first DC current value in the motor at standstill during a first predetermined time duration Δtᵢ for first magnetization of the magnetic core of the motor, and, following the first DC current injection (21a), a second DC current injection (any of 21c to 21f) of a second DC current value in the motor at standstill during a second predetermined time duration Δt₄ for second magnetization of the magnetic core of the motor. As shown on FIG. 8b, in some embodiments, the duration of the first predetermined time duration Δtᵢ may be (much) longer than the second predetermined time duration Δt₄, which advantageously allows reducing the overall duration of the improved sequence of DC injections.

The exemplary improved sequence of FIG. 8b also comprises 6 DC current injections, with the first two initial DC current injections (21a and 21b) being performed for a time duration Δtᵢ that may correspond to the time duration used in the conventional sequence of FIG. 8a., and the remaining DC injections (21c-21f) being of respective durations that are shorter than that of one or more of the first and second initial DC injections (21a and 21b). In some embodiments, the respective durations of the remaining DC injections (21c-21f) may be chosen substantially constant, for example equal to a predetermined time duration Δt₄ as shown in FIG. 8b.

FIG. 8b also illustrates exemplary magnetic flux (31a-31f) that may successively be induced in the magnetic core of the motor by the DC current injections (21a-21f) of the improved sequence: Each of the DC injections (21a-21f) induces a corresponding magnetic flux in the magnetic core of the motor, even though some of the DC current injections are of respective time durations that are much shorter than that of one or more of the first and second initial DC current injections (21a and 21b).

In one or more embodiments, the respective time durations of the first and second initial DC current injections (21a and 21b) may be chosen so as to ensure that the magnetic core of the motor reaches magnetic saturation given the respective DC current injection value of each current injection. In some embodiments, the time duration of the first and second DC current injections may be chosen substantially equal (to Δtᵢ) as shown in FIG. 8b.

In some embodiments, the two initial DC current injections (21a and 21 b) may be performed in order to obtain a demagnetization time period of the magnetic core of the motor usable for determining an estimate of the rotor time constant (τ₀), depending on the method used for determining such estimate of the rotor time constant (τ₀). As described in the present subject disclosure, in some embodiments the determination of the estimate of the rotor time constant (τ₀) may require measuring data on the motor during a demagnetization phase of the core. A first initial DC current injection (21a) may therefore be performed in order to obtain a magnetization of the core. In some embodiments, the first initial current injection (21a) may be configured (with respect to one or more of its time duration Δtᵢ and its injected DC current value), for example based on one or more features and characteristics of the motor, to perform full magnetization of the magnetic core of the motor. For example, the time duration of the first initial DC current injection may be chosen substantially equal to a few seconds (e.g. 2 seconds).

In some embodiments, once magnetization of the magnetic core of the motor is obtained through the first initial DC current injection, a demagnetization phase may be triggered by stopping the first initial DC current injection. In some embodiments, the demagnetization phase following the magnetization phase during which the first initial DC current injection is performed may be used to determine an estimate of the rotor time constant (τ₀) based on data measured on the motor during the demagnetization phase, as explained in further details in the present subject disclosure. In some embodiments, depending on the method used for determining the estimate of the rotor time constant (τ₀), the duration Δt₂ of the demagnetization phase that follows the first initial DC current injection (21a) may be chosen, for example based on one or more features and characteristics of the motor, sufficiently long in order to ensure full demagnetization of the magnetic core of the motor.

In some embodiments, once (full or partial) demagnetization of the magnetic core of the motor is obtained through waiting for the (predetermined) duration Δt₂ of the demagnetization phase before performing another DC current injection, a second initial DC current injection (21b) may be performed in order to obtain a second magnetization of the magnetic core of the motor. In some embodiments, because the demagnetization phase may be configured so as to obtain full demagnetization of the magnetic core, the second initial current injection (21b) may be configured (with respect to one or more of its time duration and its injected DC current value), for example based on one or more features and characteristics of the motor, to perform again full magnetization of the magnetic core of the motor. In some embodiments, the injected DC current value of the second initial DC current value (21b) may be chosen different from the injected DC current value of the first initial DC current value (21a) in order to generate two different data points for using as input data of the chosen method for estimating the value of the magnetic flux of the core of the motor (e.g. the hybrid method described in the present subject disclosure). For example, depending on the embodiment, the set of successive DC current injections may be configured with respective injected DC current values that form a sequence of increasing or decreasing values. The exemplary set of successive DC current injections shown on FIG. 8b shows an exemplary profile with respective injected DC current values that form a sequence of decreasing values, the first initial DC current injection being configured with the highest current value among other injected current values. However, a person skilled in the art would understand that, even though FIG. 8b shows an exemplary profile with respective injected DC current values that form a sequence of decreasing values, any suitable profile of respective injected DC values (such as for example a profile forming a sequence of decreasing values or a sequence of alternatively increasing (resp. decreasing) and decreasing (resp. increasing) values) may be used in place of such exemplary profile, which is given by way of an example only

In embodiments, because the injected DC current value of the second initial DC current value (21b) may be chosen slightly different from the injected DC current value of the first initial DC current value (21a), the time duration of the second initial DC current value (21b) may be chosen substantially equal to that (Δt₁) of the first initial DC current value (21a), as shown on FIG. 8b.

FIG. 8b also illustrates the successive demagnetizations of the magnetic core of the motor through respective decays of each of the exemplary magnetic flux (31a-31f) successively induced in the magnetic core of the motor by the DC current injections according to embodiments of the proposed method, for a demagnetization time period with no DC current injection after the end of the previous DC current injection.

In one or more embodiments, the improved sequence of DC current injections may be configured with a duration (Δt₂) of a time period with no DC current injection for demagnetization of the magnetic core of the motor after the first initial DC current injection (21a) which is longer than respective durations of respective time periods with no DC current injection for demagnetization of the magnetic core of the motor after one or more (each) of the subsequent DC current injections (21b-21f) (including the second initial DC current injection (21b).

In some embodiments, the improved sequence may be configured with a duration of the time period (Δt₂) without DC current injection for demagnetization of the magnetic core of the motor after a first DC current injection (21a) which is longer than a duration of the time period (Δt₃) with no DC current injection for demagnetization of the magnetic core of the motor after one or more (each) of the subsequent DC current injections (21b-21f), which may in some embodiments be chosen substantially constant (equal to Δt₃).

As discussed above, in some embodiments, it may be desirable to configure a time period (Δt₂) of the demagnetization phase that follows the first initial DC current injection (21a) with a duration deemed sufficient for determining an estimate of the time constant of the rotor, using any suitable method which uses data collected during a demagnetization phase (such as the method described in the present disclosure). Once data collection during this demagnetization phase for determination of this estimate is completed, the present subject disclosure suggests that the subsequent demagnetization phases (following subsequent DC current injections) may be configured (much) shorter, so as to advantageously shorten the total time duration of the sequence of DC current injections while still determining the parameters that are used for configuring the motor drive. As a consequence, in some embodiments, the respective durations of the time periods in between two successive DC current injections once the second initial DC current injection (21b) is complete may be chosen (much) shorter than the duration (Δt₁) of the demagnetization phase that follows the end of the first initial DC current injection (21a). For example, in some embodiments, the same time duration (Δt₃) may be used for one or more of the (demagnetization) time periods in between two successive DC current injections once the second initial DC current injection (21b) is complete, with Δt₃<Δt₂ (e.g. Δt₃<<Δt₂).

In some embodiments, the respective durations of the time periods in between two successive DC current injections once the second initial DC current injection (21b) is complete may be chosen (much) shorter than the duration (Δtᵢ) of the demagnetization phase that follows the end of the first initial DC current injection (21a), resulting in demagnetization phases (following the end of the second initial DC current injection (21b)) that lead to only partial demagnetization of the magnetic core, so that the respective time durations of the subsequent DC current injection may also be shortened (as compared to that of the first and second initial DC current injections). For example, in some embodiments, the same time duration (Δt₄) may be used for one or more of the subsequent DC current injections (subsequent to the second initial DC current injection), with Δt₄<Δtᵢ (e.g. Δt₄<<t₁).

As a result, the exemplary proposed improved sequence of DC current injections of FIG. 8b may in some embodiments have a total duration of 2×Δtᵢ+4×Δt₄+1×Δt₂+4×Δt₃. As compared to the exemplary conventional sequence of DC current injections of FIG. 8a which has a total duration of 6×Δtᵢ+5×Δt₂, the total duration of 2×Δt₁+4×Δt₄+1×Δt₂+4×Δt₃ is advantageously reduced because in some embodiments the time duration (Δt₄) used for one or more of the DC current injections (e.g. subsequent to the second initial DC current injection (21a)) may be configured as shorter than another DC current injection of the sequence of DC current injections (e.g. a first (21a) and/or second (21b) initial DC current injection) (Δt₄<Δt₁) (e.g. Δt₄<<Δt₁). For example, in some embodiments, a same time duration (Δt₄) may be used for one or more of the DC current injections (e.g. subsequent to the second initial DC current injection) which may be configured as shorter than another DC current injection (e.g. a first (21a) and/or second (21b) initial DC current injections) (Δt₄<Δt₁) (e.g. Δt₄<<Δt). In some embodiments, respective time durations (Δt₄ⁱ) may be used for a plurality of the DC current injections (of index i) (e.g. subsequent to the second initial DC current injection) which may be configured as shorter than another DC current injection of the sequence of DC current injections (e.g. a first (21a) and/or second (21b) initial DC current injections) (Δt₄ⁱ<Δtᵢ) (e.g. Δt₄ⁱ<<Δt₁).

Likewise, as compared to the exemplary conventional sequence of DC current injections of FIG. 8a which has a total duration of 6×Δtᵢ+5×Δt₂, the total duration of 2×Δtᵢ+4×Δt₄+1×Δt₂+4×Δt₃ is advantageously reduced because in some embodiments the time duration (Δt₃) used for one or more of the (demagnetization) time periods in between two successive DC current injections (e.g. once the second initial DC current injection (21b) is complete) may be configured as shorter than the time duration (Δt₃) used for the demagnetization time period in between two other successive DC current injections (e.g. in between a first (21a) and second (21b) initial DC current injections) (Δt₃<Δt₂) (e.g. Δt₃<<Δt₂). For example, in some embodiments, a same time duration (Δt₃) may be used for one or more of the (demagnetization) time periods in between two successive DC current injections (e.g. once the second initial DC current injection (21b) is complete) which may be configured as shorter than the time duration (Δt₃) used for the demagnetization time period in between two other successive DC current injections (e.g. in between a first (21a) and second (21b) initial DC current injections) (Δt₃<Δt₂) (e.g. Δt₃<<Δt₂). In some embodiments, respective time durations (Δt₃^{i,i+1}) may be used for a plurality of the (demagnetization) time periods in between two successive DC current injections (of respective indices i and i+1) (e.g. once the second initial DC current injection (21b) is complete, that is, i≥2) which may be configured as shorter than the time duration (Δt₃) used for the demagnetization time period in between two other successive DC current injections (e.g. in between a first (21a) and second (21b) initial DC current injections) (Δt₃^{i,i+1}<Δt₂) (e.g. Δt₃^{i,i+1}<<Δt₂)

More generally, in some embodiments, a proposed improved sequence of n DC current injections may last a total of 2×Δt₁+(n−2)×Δt₄+1×Δt₂+(n−2)×Δt₃, where Δtᵢ is the time duration of a first (and possibly—in some embodiments—a second) initial DC current injection of the sequence, Δt₂ is the time duration during which there is no DC current injection following one or more of the DC current injections (e.g. time duration for demagnetization of the core following the first initial DC current injection), Δt₄ is the time duration used for one or more of the DC current injections (e.g. subsequent to the second initial DC current injection (21a)), Δt₃ is the time duration used for one or more of the (demagnetization) time periods in between two successive DC current injections (e.g. once the second initial DC current injection (21b) is complete), and n is a non-null natural integer corresponding to the total number of DC current injections performed on the motor. In some embodiments, the total duration of the sequence of n DC current injections may advantageously be reduced because Δt₄ may be configured to verify Δt₄<Δt₁ (e.g. Δt₄<<Δt₁). In some embodiments, the total duration of the sequence of n DC current injections may advantageously be reduced because Δt₃ may be configured to verify Δt₃<Δt₂ (e.g. Δt₃<<Δt₂). In some embodiments, the total duration of the sequence of n DC current injections may advantageously be reduced through configuring both Δt₄ and Δt₃ to verify respectively Δt₄<Δtᵢ(e.g. Δt₄ Δt₁) and t₃<Δt₂ (e.g. Δt₃<<Δt₂).

The present subject disclosure further proposes a scheme for determining the duration of a shorter DC current injection, such as illustrated on FIG. 8b (DC current injections (21c)-(21f)).

In one or more embodiments, a magnetization condition of the magnetic core of the motor with respect to a DC current injection (of index j+1, following a previous DC current injection of index j in a sequence of N DC current injections in the motor (at standstill)) may be expressed as follows:

$${φ}_{j 0} + ( {φ}_{t + 1} - {φ}_{j 0} ) ( 1 - {e}^{- {t}_{inj} / {τ}_{R}} ) = ( 1 - ϵ ) {φ}_{j + 1} \\ And \\ {t}_{inj} = {τ}_{R} ln \frac{( {φ}_{j + 1} - {φ}_{j 0} )}{{ϵφ}_{j + 1}}$$

With φⱼ₀ corresponding to the initial flow of the magnetic core of the motor (prior to the DC current injection of index j+1), φⱼ corresponding to the flow of the magnetic core of the motor induced by the previous DC current injection of index j, φⱼ₊₁ corresponding to the flow of the magnetic core of the motor induced by the DC current injection of index j+1, N is the total number of DC current injections of the sequence of DC current injections, tᵢₙⱼ is the time duration during which the DC current injection of index j is performed, τ_{R} is the rotor time constant of the rotor of the motor, and ∈ is a magnetization tolerance parameter.

When using a conventional scheme according to which one waits for a complete demagnetization of the magnetic core of the motor before starting another DC current injection, that is, the DC current injection is started with the initial flow of the magnetic core of the motor (prior to the DC current injection of index j+1) being substantially equal to zero (φⱼ₀≅0), the time duration during which the DC current injection of index j+1 is performed will typically be configured as follows:

$${t}_{inj} = {τ}_{R} ln \frac{( {φ}_{j + 1} - 0 )}{{ϵφ}_{j + 1}} = {τ}_{R} ln \frac{1}{ϵ}$$

In one or more embodiments of the present disclosure, there may not be a need to wait, following one or more DC current injections of the sequence of DC current injection, for a complete demagnetization of the magnetic core of the motor before starting another DC current injection. In such embodiments, another DC current injection may be started even though the magnetic core of the motor is only partially demagnetized, that is, with the initial flow of the magnetic core of the motor (prior to the DC current injection of index j) not being substantially zero. In such case, the initial flow φⱼ₀ of the magnetic core of the motor (prior to the DC current injection of index j) may be expressed as follows:

$${φ}_{j 0} = {φ}_{j} {e}^{- {t}_{dem} / {τ}_{R}} = {φ}_{j + 1} \frac{N - j + 1}{N - j} {e}^{- {t}_{dem} / {τ}_{R}}$$

with φⱼ₀ corresponding to the initial flow of the magnetic core of the motor (prior to the DC current injection of index j+1), φⱼ corresponding to the flow of the magnetic core of the motor induced by the previous DC current injection of index j, φⱼ₊₁ corresponding to the flow of the magnetic core of the motor induced by the DC current injection of index j+1, N being the total number of DC current injections of the sequence of DC current injections, t_{dem} being the time duration of demagnetization once the previous DC current injection of index j is stopped, τ_{R} is the rotor time constant of the rotor of the motor, and ∈ is a magnetization tolerance parameter.

In such embodiments, the time duration during which the DC current injection of index j+1 is performed may advantageously be configured shorter than

$${τ}_{R} ln \frac{1}{ϵ} ,$$

as follows:

$${t}_{inj \_ short} = {τ}_{R} ln \frac{1 - \frac{N - j + 1}{N - j} {e}^{- {t}_{dem} / {τ}_{R}}}{ϵ}$$

Advantageously, one or more of the DC current injections may be configured in some embodiments with a respective time duration with is determined based on t_{inj_short} (e.g. which is substantially equal to t_{inj_short}).

Assuming that in some embodiments all but one of the DC current injections in a sequence of N DC current injections are configured with a time duration determined substantially equal to t_{inj_short}, the total gain of time obtained by shortening the duration of these shorter DC current injections can be expressed as:

$$- {τ}_{R} {\sum }_{j = 1}^{N - 1} ln ( 1 - \frac{N - j + 1}{N - j} {e}^{- {t}_{dem} / {τ}_{R}} )$$

For example, considering a sequence of N=6 DC current injections, and assuming a demagnetization of the magnetic rotor of the motor during 1.5 times the rotor time constant

$$( \frac{{t}_{dem}}{{τ}_{R}} = 1.5 ) ,$$

the total gain of time obtained by shortening the duration of these shorter DC current injections can be expressed as:

$$- {τ}_{R} {\sum }_{j = 1}^{5} ln ( 1 - \frac{7 - j}{6 - j} {e}^{- 1.5} ) = - {τ}_{R} [ ln ( 1 - \frac{6}{5} {e}^{- 1.5} ) + ln ( 1 - \frac{5}{4} {e}^{- 1.5} ) + ln ( 1 - \frac{4}{3} {e}^{- 1.5} ) + ln ( 1 - \frac{3}{2} {e}^{- 1.5} ) + ln ( 1 - 2 {e}^{- 1.5} ) ]$$

That is,

$$- {τ}_{R} {\sum }_{j = 1}^{5} ln ( 1 - \frac{7 - j}{6 - j} {e}^{- 1.5} ) = - 1.99 {τ}_{R}$$

For example, for a 650 kW motor, the rotor time constant τ_{R} may be estimated to be τ_{R}=2.66 s, so that the total gain of time obtained by shortening the duration of these 5 shorter DC current injections can be estimated to be equal to 5.306 s, which corresponds to approximately 11.15% of the total duration of the complete sequence of 6 DC current injections.

In one or more embodiments, an estimate of the rotor time constant τ₀ of the rotor of the motor operating in linear regime may be determined based on one of N voltage measurements, for purpose of applying the exponential regression method:

In one or more embodiments, an exponential regression may be used to estimate a value of a time constant of the rotor of the motor operating in linear regime based on one of the N voltage measurements.

Referring back to FIG. 6b, the voltage Vₘₑₐₛ measured at the motor's terminals during demagnetization of the magnetic core (magnetic inductance component L on FIG. 6b) of the motor may reflect such demagnetization through the following exponential decrease over time:

$${V}_{meas} ( t ) = {V}_{0} {e}^{- \frac{t}{{τ}_{0}}}$$

where V₀ is a measured voltage value at t=0, and τ₀ is the time constant of the rotor of the motor.

As shown on FIG. 7, the magnetic core of the motor may experience magnetic saturation for initial measurements of the voltage (in the example of the figure, for a duration of measurement inferior to 0.3 second). Past an initial duration of measurement (0≤t≤t_{sat_threshold}), the voltage measurement performed corresponds to a linear regime of the motor (that is, without magnetic saturation of the magnetic core).

Therefore, in some embodiments, one or more voltage measurements (at motor terminals of the motor at standstill during demagnetization of the magnetic core of the motor) may advantageously be performed for respective time measurement durations. In some embodiments, the time measurement duration may be predefined for one or more of the voltage measurements, for example based on a theoretical value of the rotor time constant of the motor. For example, the time measurement duration may be predefined for one or more of the voltage measurements as a multiple (e.g. 8) of theoretical value of the rotor time constant of the motor.

In one or more embodiments, one or more of the N voltage measurements (at motor terminals of the motor at standstill during demagnetization of the magnetic core of the motor) may be used for determining an estimate of the rotor time constant τ₀. The time duration of one or more of the N voltage measurements may be determined so that the voltage measurement can be used for both the determination of an estimate of the rotor time constant during demagnetization of the core and the determination of an estimate of the magnetic flux (φⱼ) in the magnetic core of the motor during demagnetization of the core as described above (e.g. through integration of the measured voltage over the time duration).

In one or more embodiments, for each of one or more of the plurality of N voltage measurements, the measurement of the voltage for the voltage measurement period may generate a plurality of S voltage measurement data points (vᵢ)_{1≤i≤S}, S being a non-zero natural integer. In some embodiments, the S voltage measurement data points (vᵢ)_{1≤i≤S} are obtained through measurement sampling with a sampling interval (Δt). Therefore, in some embodiments, S duplets of voltage measurement data point vᵢ and acquisition time tᵢ of the corresponding voltage measurement data point v within the voltage measurement period may be generated through the plurality of S voltage measurement data points (vᵢ)_{1≤i≤S} comprised in the voltage measurement of the voltage at motor terminals of the motor at standstill during the (initial) part of demagnetization of the magnetic core of the motor. In some embodiments, the voltage measurement period may correspond to the time interval t_{S}−t₁. In some embodiments, the plurality of S data points (tᵢ, vᵢ)_{1≤i≤S} may be determined based on the voltage measurement.

In some embodiments, in order to estimate the value of the rotor time constant during linear magnetization, an exponential regression may be applied, preferably once the voltage is linear (during the linear regime of the motor) as the exponential regression may use a linear regression algorithm applied on the log (vᵢ) data.

In order to use an exponential regression on a data set, in some embodiments, the logarithm of one or more of the data of the data set, e.g. one or more of the plurality of S voltage measurement data points (vᵢ)_{1≤i≤S} may be determined, in order to apply a linear regression algorithm.

In some embodiments, one may then consider a set of S time-voltage data points to be exponentially fitted: (tᵢ, vᵢ)_{1≤i≤S}, with an exponential relation between the time duration tᵢ and the voltage variable vᵢ, such as for example:

$${v}_{i} = {V}_{0} {e}^{- \frac{{t}_{i}}{{τ}_{0}}}$$

where V₀ is an initial voltage measurement value (at t=0), and τ₀ is a time constant.

Taking the logarithm of vᵢ leads to:

$$log ( {v}_{i} ) = log ( {V}_{0} ) - \frac{{t}_{i}}{{τ}_{0}}$$

In some embodiments, a linear regression may therefore be applied to the log data set (tᵢ, log vᵢ)_{1≤i≤N}, for example using the following equations:

$$log {\hat{V}}_{0} = \frac{\sum {t}_{i} \sum {t}_{i} log {v}_{i} - \sum {t}_{i}^{2} \sum log {v}_{i}}{{( \sum {t}_{i} )}^{2} - N \sum {t}_{i}^{2}} \\ and \\ - \frac{1}{{\hat{τ}}_{0}} = \frac{\sum {t}_{i} \sum log {v}_{i} - N \sum {t}_{i} log {v}_{i}}{{( \sum {t}_{i} )}^{2} - N \sum {t}_{i}^{2}}$$

Therefore, in some embodiments, an estimate to of the rotor time constant τ₀ may be determined based on the following:

$${\hat{τ}}_{0} = - \frac{{( \sum {t}_{i} )}^{2} - N \sum {t}_{i}^{2}}{\sum {t}_{i} \sum log {v}_{i} - N \sum {t}_{i} log {v}_{i}}$$

The dominance of the demagnetization process phase where the inner core is under linear magnetization (which, as shown on FIG. 7, follows a short magnetic saturation phase of the core) over such magnetic saturation phase will minimize the impact of having some data points which may be chosen from slightly before the full entry in the magnetic linear zone, which advantageously confers a stronger robustness to the estimate of the rotor time constant according to embodiments of the proposed scheme.

In one or more embodiments in which the above-described hybrid method for estimating the magnetic flux of the core is used, the second magnetic flux estimate component may be determined based on the estimate \hat{τ}₀ of the rotor time constant by combining such estimate with c selected in the neighborhood of the last voltage measurement point (vₛ). The one or more voltage measurement data points of the plurality of S voltage measurement data points (vᵢ)_{1≤i≤S} may be selected based on that they correspond to a switching time within the demagnetization process period from use of the integration method to use of the exponential regression method (e.g. to a transition time between the first time period showing saturation and the second time period without saturation).

For example, in some embodiments, the second magnetic flux estimate component may be determined by combining the estimate \hat{τ}₀ of the rotor time constant with the last voltage measurement point (vₛ), e.g. based on the product \hat{τ}₀·vₛ, as the last voltage measurement point (vₛ) may in some embodiments correspond to a switching time within the demagnetization process period from use of the integration method to use of the exponential regression method (e.g. to a transition time between the first time period showing saturation and the second time period without saturation).

Therefore, in one or more embodiments, a method switching time (tₛₜ) may be considered, which corresponds to a switching time within the demagnetization process period from use of the integration method to use of the exponential regression method (e.g. to a transition time between the first time period showing saturation in which the integration is applied, and the second time period without saturation in which the exponential regression is applied). In some embodiments, the method switching time (tₛₜ) may correspond to SΔt, where S is the number of voltage measurement data points acquired during the voltage measurement period, and Δt is the sampling period for acquisition of the voltage measurement data points).

In one or more embodiments, the method switching time (tₛₜ) may be a parameter of the proposed method configured (determined) based on a primary estimate of the rotor time constant. Such primary estimate of the rotor time constant of the induction motor may be provided by the manufacturer of the motor in the data sheet of the motor. Therefore, in embodiments where the voltage measurement for the voltage measurement period comprises a plurality of S voltage measurement data points (vᵢ)_{1≤i≤S}, the number S of voltage measurement data points (vᵢ)_{1≤i≤S} to be acquired during demagnetization of the magnetic core of the motor may be chosen based on the primary estimate of the rotor time constant, for example based on a multiple of the primary estimate of the rotor time constant (e.g. 2 or 3 times the primary estimate of the rotor time constant).

In some embodiments, the integration method may be applied to voltage measured from the beginning of the demagnetization process up to the method switching time (tₛₜ), and a first magnetic flux estimate may be determined based on results of the integration method, and the exponential regression method may be used to determine a second magnetic flux estimate component that corresponds to the demagnetization of the core from the method switching time (tₛₜ) to the end of the demagnetization.

In one or more embodiments, the second magnetic flux estimate component may be determined based on one or more voltage measurement data points of the plurality of S voltage measurement data points (vᵢ)_{1≤i≤S} (e.g. based on the last voltage measurement point vₛ), or based on an average voltage value (\tilde{v}ₛ) averaging a plurality of voltage measurement data points of the plurality of S voltage measurement data points (vᵢ)_{1≤i≤S} (for example selected in the neighborhood among the plurality of S voltage measurement data points (vᵢ)_{1≤i≤S} of the last voltage measurement point (vₛ)).

In some embodiments, each of the plurality of voltage measurement data points selected for determining the average voltage value may be comprised in a set of {Vₛ₊ₖ}_{-2K≤k≤0}, wherein K is a non-zero natural integer. In some embodiments, an average voltage value (\tilde{v}ₛ) averaging a plurality of voltage measurement data points of the plurality of S voltage measurement data points (vᵢ)_{1≤i≤S} may be determined, for example according to the following formula:

$${\tilde{v}}_{S} = \frac{1}{2 K} {\sum }_{- 2 K \leq k \leq 0} {v}_{S + k}$$

This average voltage value may in some embodiments provide an average voltage value at the method switching time (tₛₜ).

In one or more embodiments, the voltage measurement at terminals of the motor at standstill may be performed during a preconfigured voltage measurement period and may be pursued for some time after expiry of the voltage measurement period. For example, voltage measurement data points may still be acquired after the end of the preconfigured voltage measurement period. In some embodiments, voltage measurement data points acquired after the end of the preconfigured voltage measurement period may be used to calculate an average voltage value at the method switching time (tₛₜ), for example according to the following formula:

$${\tilde{v}}_{S} = \frac{1}{2 K} {\sum }_{- K \leq k \leq K} {v}_{S + k}$$

Using an average value advantageously allows rejecting high-frequency noise measurements and provides a better representative value of the voltage at the instant of the demagnetization process corresponding to the method switching time (tₛₜ).

In one or more embodiments, the second magnetic flux estimate component may be determined by combining the estimate to of the rotor time constant with the average voltage value at the method switching time (\tilde{v}ₛ), e.g. based on the product \hat{τ}₀·\tilde{v}ₛ,

Therefore, in some embodiments, the exponential regression method may provide an estimate \hat{τ}₀ of the rotor time constant, and such estimate may be combined with a voltage value corresponding to the method switching time, such as, in some embodiments, an average voltage value corresponding to the method switching time.

In one or more embodiments, an estimate \hat{φ} the magnetic flux of the magnetic core of the motor after magnetization (e.g. resulting from a DC injection) may be determined based on the following formula:

$$\hat{φ} = Δ t {\sum }_{i = 1}^{S} {v}_{i} + {\hat{τ}}_{0} {\tilde{v}}_{S}$$

where \hat{t}₀ is an estimate of a time constant of the rotor of the motor, S is the number of voltage measurement data points (vᵢ)_{1≤i≤S} obtained through voltage measurement sampling with a sampling interval (Δt), and \tilde{v}ₛ is an average voltage value at a method switching time configured based on S·Δt. For example, the average voltage value \tilde{v}ₛ may be determined based on the following formula:

$${\tilde{v}}_{S} = \frac{1}{2 K} {\sum }_{- K \leq k \leq K} {v}_{S + k}$$

or, depending on the embodiment, based on the following formula:

$${\tilde{v}}_{S} = \frac{1}{2 K} {\sum }_{- 2 K \leq k \leq 0} {v}_{S + k}$$

Therefore, advantageously, in order to benefit from each of the advantages of both the integration method and the exponential regression method, the proposed scheme advantageously uses the integration method at the beginning of the demagnetization process of the magnetic core, where magnetic saturation is most likely occurring, and then, after a preconfigured time interval, switches to the exponential regression method to account for the remaining flux of the demagnetization process. This hybridization offers a number of benefits. For example, errors are less likely to accumulate and become non-negligible because the integration method is not used for a time as long as the entire demagnetization process. In addition, observing that the saturation effect is influencing only for a multiple of (e.g., the first one to two times) the rotor time constant, the integration method will take into account this effect, and the remaining part of the voltage signal can be more trustfully considered as exponentially decreasing and then, be processed more efficiently by the exponential regression method. Finally, because the flux can be easily calculated mathematically once the parameters of the exponential curve are accurately estimated, the exponential regression advantageously allows estimating the flux before the measured voltage completely decays which makes the proposed method time-saving.

A primary estimation of the rotor time constant may advantageously be used to set the parameter for the switching instant between these two methods.

In one or more embodiments, an estimate of a rotor resistance (Rᵣ) of the motor may be determined based on the estimates of the magnetic inductance component (L₀) of the motor and the rotor time constant (\hat{τ}₀).

Noting that the time constant of an inductance-resistor parallel circuit such as the magnetic inductance component L and rotor resistance Rᵣ of the model circuit of FIG. 2 may be expressed as

$$τ = \frac{L}{{R}_{r}} ,$$

the rotor resistance Rᵣ may in some embodiments be estimated based on the ratio L₀/\hat{t}₀ of the estimate of the magnetic inductance component (L₀) of the motor over the estimate of the rotor time constant (\hat{t}₀). For example, in some embodiments, the rotor resistance Rᵣ as

$${R}_{r} = \frac{{L}_{0}}{{\hat{τ}}_{0}} .$$

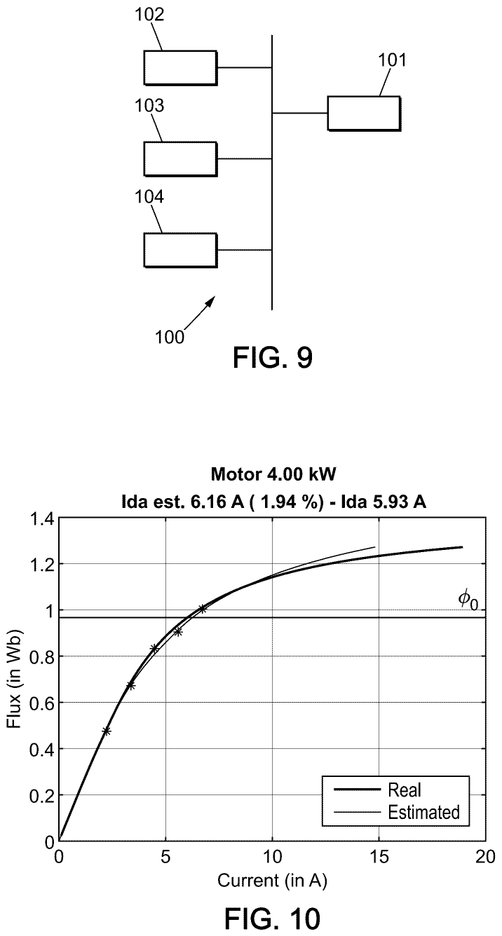

FIG. 9 illustrates an exemplary motor drive apparatus 100 configured to use features in accordance with embodiments of the present subject disclosure.

The motor drive apparatus 100 may include a control engine 101, a motor drive engine 102, motor interface engine 103, a memory 105, and a power supply (e.g., a battery, plug-in power supply, etc.) (not represented on the figure). The motor drive apparatus may be configured with a data communication interface (not represented on the figure) configured for coupling the apparatus to an induction motor (through one or more motor terminals of the motor) for driving the induction motor through the data communication interface (not represented on the figure), and/or with an electrical signal interface for electrical coupling of the apparatus 103 with an induction motor (through one or more motor terminals of the motor).

In the architecture illustrated on FIG. 9, all of the motor drive engine 102, motor interface engine 103, and memory 104 are operatively coupled with one another through the control engine 101.

In one or more embodiments, the motor drive engine 102 is configured to perform various aspects of embodiments of the proposed methods for configuring a motor drive as described in the present subject disclosure. For example, in some embodiments, the motor interface engine 103 may be configured to perform a first Direct Current, DC, current injection of a first DC current value in the motor at standstill during a first predetermined time duration for first magnetization of the magnetic core of the motor, and to perform, further to (e.g. following) the first DC current injection, a second DC current injection of a second DC current value in the motor at standstill during a second predetermined time duration for second magnetization of the magnetic core of the motor, wherein the second predetermined time duration is shorter than the first predetermined time duration.

In one or more embodiments, the motor interface engine 103 is configured to manage one or more of a data communication interface and electrical signal interface with the motor in situations where the motor drive apparatus 100 is coupled to a motor to be driven. For example, in some embodiments, the motor interface engine 103 may be configured to perform a plurality of N measurements of a voltage at motor terminals of the motor at standstill during demagnetization of the magnetic core of the motor. For example, in some embodiments, the motor interface engine 103 may be configured to perform a first DC current injection of a first DC current value in the motor at standstill during a first predetermined time duration for first magnetization of the magnetic core of the motor, and to perform, further to (e.g. following) the first DC current injection, a second DC current injection of a second DC current value in the motor at standstill during a second predetermined time duration for second magnetization of the magnetic core of the motor, wherein the second predetermined time duration is shorter than the first predetermined time duration.

The control engine 101 includes a processor, which may be any suitable microprocessor, microcontroller, Field Programmable Gate Arrays (FPGA), Application Specific Integrated Circuits (ASIC), Digital Signal Processing chip, and/or state machine, or a combination thereof. According to various embodiments, one or more of the computers can be configured as a multi-processor computer having multiple processors for providing parallel computing. The control engine 101 may also comprise, or may be in communication with, computer storage media, such as, without limitation, the memory 104, capable of storing computer program instructions or software code that, when executed by the processor, causes the processor to perform the elements described herein. In addition, the memory 104 may be any type of data storage computer storage medium, capable of storing a data structure representing a computer network to which the motor drive apparatus 100 belongs, coupled to the control engine 101 and operable with the motor interface engine 103 and the motor drive engine 102 to facilitate management and processing of data stored in association therewith.

In embodiments of the present subject disclosure, the motor drive apparatus 100 is configured for performing the methods described herein.

It will be appreciated that the motor drive apparatus 1 shown and described with reference to FIG. 9 is provided by way of example only. Numerous other architectures, operating environments, and configurations are possible. Other embodiments of the node may include fewer or greater number of components, and may incorporate some or all of the functionality described with respect to the motor drive apparatus components shown in FIG. 9. Accordingly, although the control engine 101, motor drive engine 102, motor interface engine 103, and memory 104 are illustrated as part of the motor drive apparatus 100, no restrictions are placed on the location and control of components 102-104. In particular, in other embodiments, components 102-104 may be part of different entities or computing systems.

Depending on the embodiment, the apparatus 100 may be implemented in software, as described above, or in hardware, such as an application specific integrated circuit (ASIC), or in the form of a combination of hardware and software, such as for example a software program intended to be loaded and executed on a component of FPGA (Field Programmable Gate Array) type.

Performances of a method for estimating the rotor time constant τ₀ (which can be thereafter used as a parameter for configuring the motor drive) as described herein are illustrated by FIG. 10, which shows a flux vs current curve of a real motor and an estimated flux vs current curve using the proposed scheme. As shown in FIG. 10, using a real test bench, the proposed method gives a magnetizing curve which is very close to the real one. In FIG. 10, the horizontal line indicates the nominal flux that needs to be applied when the motor is controlled. The “Ida” notation (which designates the nominal fluxing current of the motor) refers to the magnetizing current that generates the nominal flux. In the performance test illustrated on the figure, 5 DC injections were made, and 5 corresponding flux values were estimated. The saturation model is then fitted on these 5 points and the resulting magnetizing curve is shown in the bold line. The other curve shows the real magnetizing curve.

The rotor resistance was estimated using a single DC injection for estimating the rotor time constant τ₀, and 5 DC injections (an additional 4 DC injections) for estimating the inductance component in linear mode L₀.

Results are reported in the following Table 1 from which we can see the proposed method's low error value, which provides a performance level comparable to the rotational tune but with a lot fewer restrictions because the proposed method does not call for mechanical decoupling of the motor.

TABLE 1

| | | | |
|---|---|---|---|
| | Reference | Estimated | |
| Motor | Rotor | Rotor | |
| power | Resistance | Resistance | Error |

| | | | | | | |
|---|---|---|---|---|---|---|
| 0.7500 | kW | 4682. | mO | 4599. | mO | −1.77% |
| 7.500 | kW | 267.3 | mO | 292.6 | mO | 9.49% |
| 11.00 | kW | 175.1 | mO | 179.7 | mO | 2.59% |
| 15.00 | kW | 157.9 | mO | 168.4 | mO | 6.68% |
| 22.00 | kW | 60.73 | mO | 63.29 | mO | 4.22% |
| 90.00 | kW | 9.507 | mO | 9.244 | mO | −2.77% |
| 250.0 | kW | 2.746 | mO | 3.007 | mO | 9.53% |

While the present subject disclosure has been described with respect to preferred embodiments, those skilled in the art will readily appreciate that various changes and/or modifications can be made to the present subject disclosure without departing from the spirit or scope of the present subject disclosure as defined by the appended claims.

Although this present subject disclosure has been disclosed in the context of certain preferred embodiments, it should be understood that certain advantages, features and aspects of the systems, devices, and methods may be realized in a variety of other embodiments. Additionally, it is contemplated that various aspects and features described herein can be practiced separately, combined together, or substituted for one another, and that a variety of combination and sub-combinations of the features and aspects can be made and still fall within the scope of the present subject disclosure. Furthermore, the systems and devices described above need not include all of the modules and functions described in the preferred embodiments.

Information and signals described herein can be represented using any of a variety of different technologies and techniques. For example, data, instructions, commands, information, signals, bits, symbols, and chips can be represented by voltages, currents, electromagnetic waves, magnetic fields or particles, optical fields or particles, or any combination thereof.

Depending on the embodiment, certain acts, events, or functions of any of the methods described herein can be performed in a different sequence, may be added, merged, or left out all together (e.g., not all described acts or events are necessary for the practice of the method). Moreover, in certain embodiments, acts or events may be performed concurrently rather than sequentially.

1. A method for configuring a motor drive for driving an induction motor which comprises a rotor and a magnetic core comprising a magnetic inductance component, the method comprising:
performing a first Direct Current, DC, current injection of a first DC current value in the motor at standstill during a first predetermined time duration for first magnetization of the magnetic core of the motor;
performing, further to the first DC current injection, a second DC current injection of a second DC current value in the motor at standstill during a second predetermined time duration for second magnetization of the magnetic core of the motor;
wherein the second predetermined time duration is shorter than the first predetermined time duration.

2. The method according to claim 1, further comprising: configuring the motor drive based on the first and second DC current injections.

3. The method according to claim 1, wherein the second DC current value is smaller than the first DC current value.

4. The method according to claim 1, further comprising:
performing a plurality of N subsequent DC current injections in the motor at standstill during respective predetermined time durations, wherein N is an integer greater than 3, wherein the plurality of N subsequent DC current injections includes the first and second DC current injections, and wherein one or more of the respective predetermined time durations of the N−1 DC current injections subsequent to the first DC current injection are shorter than the first predetermined duration of the first DC injection.

5. The method according to claim 4, wherein the second DC injection is performed upon end of a first predetermined in-between injection time duration following the first predetermined time duration, and one or more predetermined in-between injection time durations between respective pairs of subsequent DC current injections among the N−2 DC current injections subsequent to the first and second DC current injections are shorter than the first predetermined in-between injection time duration.

6. The method according to claim 1, wherein the respective DC current values of the N subsequent DC current injections are decreasing from a DC current value of a i^{th} DC current injection to a DC current value to a subsequent (i+1)^{th} DC current injection.

7. The method according to claim 1, further comprising:
performing each of a plurality of N measurements of a voltage at motor terminals of the motor at standstill during demagnetization of the magnetic core of the motor further to a respective DC current injection of the plurality of N subsequent DC current injections;
determining, based on the N voltage measurements, an estimate of the magnetic inductance component of the motor operating in linear regime;
determining, based on one of the N voltage measurements, an estimate of a time constant of the rotor of the motor operating in linear regime;
determining an estimate of a rotor resistance of the motor based on the estimates of the magnetic inductance component of the motor and the rotor time constant.

8. The method according to claim 7, further comprising: configuring the motor drive based on the estimate of the rotor resistance of the motor.

9. The method according to claim 1, further comprising: for each voltage measurement, determining an estimate of a magnetic flux in the magnetic inductance component of the motor based on the voltage measurement.

10. The method according to claim 1, further comprising: determining a plurality of N duplets of current and magnetic flux values, based on the N voltage measurements performed further to injecting respective values of DC current in the motor at standstill for respective time periods.

11. The method according to claim 1, wherein the motor is an asynchronous induction motor.

12. An apparatus comprising a processor, a memory operatively coupled to the processor, and an interface for coupling to an induction motor to be driven by the apparatus, wherein the apparatus is configured to perform a method for configuring a motor drive for driving the induction motor which comprises a rotor and a magnetic core comprising a magnetic inductance component, the method comprising:
performing a first Direct Current, DC, current injection of a first DC current value in the motor at standstill during a first predetermined time duration for first magnetization of the magnetic core of the motor;
performing, further to the first DC current injection, a second DC current injection of a second DC current value in the motor at standstill during a second predetermined time duration for second magnetization of the magnetic core of the motor;
wherein the second predetermined time duration is shorter than the first predetermined time duration.

13. (canceled)

14. (canceled)

15. A non-transitory computer-readable medium encoded with executable instructions which, when executed, causes an apparatus comprising a processor operatively coupled with a memory, to perform a method for configuring a motor drive for driving an induction motor which comprises a rotor and a magnetic core comprising a magnetic inductance component, the method comprising:
performing a first Direct Current, DC, current injection of a first DC current value in the motor at standstill during a first predetermined time duration for first magnetization of the magnetic core of the motor;
performing, further to the first DC current injection, a second DC current injection of a second DC current value in the motor at standstill during a second predetermined time duration for second magnetization of the magnetic core of the motor;
wherein the second predetermined time duration is shorter than the first predetermined time duration.

16. The apparatus according to claim 12, wherein the method further comprises: configuring the motor drive based on the first and second DC current injections.

17. The apparatus according to claim 12, wherein the second DC current value is smaller than the first DC current value.

18. The apparatus according to claim 12, wherein the method further comprises: performing a plurality of N subsequent DC current injections in the motor at standstill during respective predetermined time durations, wherein N is an integer greater than 3, wherein the plurality of N subsequent DC current injections includes the first and second DC current injections, and wherein one or more of the respective predetermined time durations of the N−1 DC current injections subsequent to the first DC current injection are shorter than the first predetermined duration of the first DC injection.

19. The apparatus according to claim 18, wherein the second DC injection is performed upon end of a first predetermined in-between injection time duration following the first predetermined time duration, and one or more predetermined in-between injection time durations between respective pairs of subsequent DC current injections among the N−2 DC current injections subsequent to the first and second DC current injections are shorter than the first predetermined in-between injection time duration.

20. The non-transitory computer-readable medium according to claim 15, wherein the method further comprises: configuring the motor drive based on the first and second DC current injections.

21. The non-transitory computer-readable medium according to claim 15, wherein the second DC current value is smaller than the first DC current value.

22. The non-transitory computer-readable medium according to claim 15, wherein the method further comprises: performing a plurality of N subsequent DC current injections in the motor at standstill during respective predetermined time durations, wherein N is an integer greater than 3, wherein the plurality of N subsequent DC current injections includes the first and second DC current injections, and wherein one or more of the respective predetermined time durations of the N−1 DC current injections subsequent to the first DC current injection are shorter than the first predetermined duration of the first DC injection.
